(19) United States
(12) Patent Application Publication
(10) Pub. No.: US 2018/0258559 A1
(43) Pub. Date: Sep. 13, 2018

(54) MATERIALS FOR IMPROVED POLYMERIC 3D PRINTING

(71) Applicant: University of Tennessee Research Foundation, Knoxville, TN (US)

(72) Inventors: Mark Dadmun, Knoxville, TN (US); Neiko Phillip Levenhagen, Knoxville, TN (US)

(21) Appl. No.: 15/455,978

(22) Filed: Mar. 10, 2017

(51) Int. Cl. D01F 8/14; C08L 67/04; B33Y 10/00; B33Y 70/00; B33Y 80/00; B29C 67/00; B33Y 50/02

(52) U.S. Cl. CPC D01F 8/14; C08L 67/04; B33Y 10/00; B33Y 70/00; B29K 2067/046; B29C 67/0055; B29C 67/0088; B33Y 50/02; C08L 2205/025; B33Y 80/00

(57) ABSTRACT

Polymeric blends and filaments prepared from the blends are provided for improving isotropy in three-dimensional objects prepared by fused deposition modeling (FDM) processes. The polymeric blends include a high molecular weight (HMW) thermoplastic polymer and an additive comprising a low molecular weight (LMW) thermoplastic polymer. The HMW and LMW polymers can be the same type of polymer (e.g., poly(lactic acid)) or have at least one type of monomeric unit in common. The LMW polymer additive can have a molecular weight that is greater than the entanglement molecular weight and is about half the molecular weight of the HMW polymer or less. Inclusion of the LMW polymer can increase interfacial adhesion between filaments prepared from the blends. Also provided are three-dimensional objects prepared from a FDM process that have improved isotropic properties and methods of improving the isotropic properties of a three-dimensional object.

### GOVERNMENT INTEREST

This invention was made with government support under DE-NA0002839 awarded by the Department of Energy (DOE). The government has certain rights in the invention.

### TECHNICAL FIELD

The presently disclosed subject matter relates to polymer blends for making filaments for fused deposition modeling (FDM) applications. In some embodiments, the blends comprise a high molecular weight polymer and a low molecular weight polymer additive. Filaments comprising the blends can be used to provide objects with improved isotropic properties and/or improved interfacial adhesion between layers of filament.

### ABBREVIATIONS

° C.=degrees Celsius
% percentage
μL=microliter
3D=three-dimensional
ABS=acrylonitrile butadiene styrene terpolymer
CAD=computer assisted design program
DSC=differential scanning calorimetry
FDM=fused deposition modeling
FFF=fused filament fabrication
g=grams
Gₐ=interfacial adhesion
GPa=gigapascal
GPC=gel permeation chromatography
HMW=high molecular weight
hrs=hours
iPrOH=isopropyl alcohol
J=joules
K=Kelvin
kDa (or k)=kilodalton
LMW=low molecular weight
Mₑ=entanglement molecular weight
min=minute
mL=milliliter
mm=millimeter
Mₙ=number average molar mass
mol=mole
mol %=mole percentage
MPa=megapascal
M_{w}=mass average molar mass
PDI=polymer dispersity index
PLA=poly(lactic acid)
T_{c}=crystallization temperature
Tₘ=melting temperature

### BACKGROUND

Fused deposition modeling (FDM) has been used as a rapid prototyping technique for many years and has achieved large commercial success. It is often used to model prototype designs for cars, medical prostheses, buildings, and many other design processes. There is a growing desire to expand the technique to build structural and functional parts.

Accordingly, there is a need for additional materials to use as building materials (e.g., in preparing polymer filaments) for FDM. In particular, there is a need for materials that can be used to produce polymeric filaments that have more isotropic properties and/or can provide three-dimensional objects with higher modulus, toughness, and/or stress at yield.

### SUMMARY

In some embodiments, the presently disclosed subject matter provides a polymer blend comprising: (a) a high molecular weight (HMW) thermoplastic polymer, and (b) a low molecular weight (LMW) thermoplastic polymer; wherein the HMW thermoplastic polymer has a weight average molecular weight (M_{w}) that is at least two times greater than the M_{w} of the LMW thermoplastic polymer; wherein the blend comprises between 0.5 weight % and about 15 weight % of the LMW thermoplastic polymer; and wherein the HMW thermoplastic polymer and the LMW thermoplastic polymer are each independently selected from the group comprising poly(lactic acid (PLA), acrylonitrile butadiene styrene terpolymer (ABS), a polyetherimide (PEI), polyethyl ether ketone (PEEK), a polyether ketone ketone (PEKK), a polystyrene (PS), polyphenylsulfone (PPSF), glycol-modified polyethylene terephthalate (PETG), a polyester, a polyamide (PA), and polycarbonate (PC)

In some embodiments, the M_{w} of the HMW thermoplastic polymer is four to eight times greater than the M_{w} of the LMW thermoplastic polymer. In some embodiments, the HMW thermoplastic polymer and/or the LMW thermoplastic polymer are selected from the group consisting of PLA and ABS. In some embodiments, the LMW thermoplastic polymer has a M_{w} that is greater than the entanglement molecular weight (Mₑ) of the thermoplastic polymer.

In some embodiments, the HMW thermoplastic polymer and the LMW thermoplastic polymer are polymers derived from the polymerization of the same monomer or monomers. In some embodiments, the HMW thermoplastic polymer and the LMW thermoplastic polymer are both PLA.

In some embodiments, the LMW thermoplastic polymer has a M_{w} of between about 25,000 g/mol and about 100,000 g/mol. In some embodiments, the LMW thermoplastic polymer has a M_{w} of about 50,000 g/mol.

In some embodiments, the LMW thermoplastic polymer comprises between about 3 mole percentage (mol %) and about 15 mol % of the blend. In some embodiments, the LMW thermoplastic polymer has a M_{w} of about 50,000 g/mol and comprises about 10 mol % of the blend.

In some embodiments, the blend has a polydispersity index (PDI) of between about 2.1 and about 3.0.

In some embodiments, the presently disclosed subject matter provides a filament comprising a polymer blend, wherein the polymer blend comprises: (a) a HMW thermoplastic polymer, and (b) a LMW thermoplastic polymer; wherein the HMW thermoplastic polymer has a M_{w} that is at least two times greater than the M_{w} of the LMW thermoplastic polymer; and wherein the blend comprises between 0.5 weight % and about 5 weight % of the LMW thermoplastic polymer.

In some embodiments, the HMW thermoplastic polymer and the LMW thermoplastic polymer are each selected from the group comprising PLA, ABS, a PEI, a PEEK, a PEKK, a PS, PPSF, PETG, a polyester, a PA, and PC. In some embodiments, the M_{w} of the HMW thermoplastic polymer is about four to eight times greater than the M_{w} of the LMW thermoplastic polymer. In some embodiments, the LMW thermoplastic polymer has a M_{w} that is greater than the Mₑ of the thermoplastic polymer.

In some embodiments, the HMW thermoplastic polymer and the LMW thermoplastic polymer are polymers derived from the polymerization of the same monomer or monomers. In some embodiments, the HMW thermoplastic polymer and the LMW thermoplastic polymer are both PLA.

In some embodiments, the LMW thermoplastic polymer has a M_{w} of between about 25,000 g/mol and about 100,000 g/mol. In some embodiments, the LMW thermoplastic polymer has a M_{w} of about 50,000 g/mol.

In some embodiments, the LMW thermoplastic polymer comprises between about 3 mol % and about 15 mol % of the blend. In some embodiments, the LMW thermoplastic polymer has a M_{w} of about 50,000 g/mol and comprises about 10 mol % of the blend.

In some embodiments, the filament has a diameter of between about 4 mm and about 0.5 mm. In some embodiments, the filament further comprises one or more additives selected from the group comprising pigments, UV stabilizers, UV absorbers, antioxidants, lubricity agents, heat stabilizers, hydrolysis stabilizers, cross-linking activators, flame retardants, layered silicates, an organic or inorganic filler, a colorant, an adhesion mediator, an impact strength modifier, an antimicrobial, and combinations thereof.

In some embodiments, the presently disclosed subject matter provides a three-dimensional object comprising a plurality of adjacent layers of a filament of comprising a polymer blend, wherein the polymer blend comprises: (a) a HMW thermoplastic polymer, and (b) a LMW thermoplastic polymer; wherein the HMW thermoplastic polymer has a M_{w} that is at least two times greater than the M_{w} of the LMW thermoplastic polymer; and wherein the blend comprises between 0.5 weight % and about 5 weight % of the LMW thermoplastic polymer.

In some embodiments, the object has improved isotropic properties compared to an object of the same design prepared from a filament comprising no LMW thermoplastic polymer. In some embodiments, the object has a difference between modulus measured in the transverse direction and modulus measured in the longitudinal direction of 0.02 gigapascals (GPa) or less. In some embodiments, the object has a difference between stress at yield measured in the transverse direction and stress at yield measured in the longitudinal direction of 15 megapascals (MPa) or less.

In some embodiments, the object has one or more of maximum stress in the longitudinal direction, maximum stress in the transverse direction, modulus in the longitudinal direction, modulus in the transverse direction, and toughness that is higher than that of an object of the same design prepared from a filament comprising no LMW thermoplastic polymer. In some embodiments, the object has a maximum stress in the transverse direction that is at least 40% greater than in an object of the same design prepared from a filament comprising no LMW thermoplastic polymer. In some embodiments, the object has a modulus in the transverse direction that is at least 25% greater than in an object of the same design prepared from a filament comprising no LMW thermoplastic polymer.

In some embodiments, the presently disclosed subject matter provides a method of preparing a three-dimensional object, wherein the method comprises: (i) providing a filament comprising a polymer blend, wherein the polymer blend comprises: (a) a HMW thermoplastic polymer, and (b) a LMW thermoplastic polymer; wherein the HMW thermoplastic polymer has a M_{w} that is at least two times greater than the M_{w} of the LMW thermoplastic polymer; and wherein the blend comprises between 0.5 weight % and about 5 weight % of the LMW thermoplastic polymer; (ii) heating the filament; and (iii) dispensing heated filament to form a plurality of adjacent layers of dispensed filament, thereby preparing the three-dimensional object.

In some embodiments, step (iii) comprises: (1) dispensing heated filament from a print head while moving the print head in a first two dimensional plane to form a first layer of dispensed filament on a support surface; (2) moving the print head or support surface in a direction perpendicular to the first two dimensional plane; (3) dispensing heated filament from the print head while moving the print head in a second two dimensional plane, wherein the second two dimensional plane is parallel to the two dimensional plane of step (1) to form a second layer of dispensed filament, wherein at least a portion of the second layer is in contact with the first layer; and (4) repeating the moving of the print head or support surface and the dispensing of heated filament to form one or more additional layers layer-by-layer, wherein each of the additional layers is in contact with at least a portion of the adjacent layer or layers. In some embodiments, the movement of the print head and/or the support surface is controlled by a motor and/or computer.

In some embodiments, the presently disclosed subject matter provides a method of improving the isotropy of an object prepared via a fused deposition modeling three-dimensional printing process, wherein the method comprises adding a low molecular weight polymer to a high molecular weight polymer to provide a bimodal polymer blend for use in preparing a building material for the object, wherein the addition of the low molecular weight polymer improves interfacial adhesion between layers of building material within the object.

Accordingly, it is an object of the presently disclosed subject matter to provide polymer blends and filaments prepared from the polymer blends, as well as 3D objects prepared from the filaments and methods of preparing 3D objects using the filaments.

An object of the presently disclosed subject matter having been stated hereinabove, and which is achieved in whole or in part by the presently disclosed subject matter, other objects will become evident as the description proceeds hereinbelow.

### BRIEF DESCRIPTION OF THE DRAWINGS

FIG. 1 is a schematic drawing of tensile specimens prepared by fused deposition modeling three-dimensional printing. The top specimen illustrates a specimen prepared using transverse raster orientation. The bottom specimen illustrates a specimen prepared using longitudinal raster orientation.

FIG. 2 is a photograph of a t-peel sample prepared via fused deposition modeling three dimensional printing during testing to determine interfacial adhesion.

FIG. 3 is a graph showing the average tensile stress (in megapascals (MPa)) versus extension (in millimeters (mm)) of t-peel samples prepared from 100% 220 kiloDalton (kDa) poly(lactic acid) (PLA) filaments (Neat), filaments prepared from a blend of 220 kDa PLA containing 10 mole percentage (mol %) 50 kDa PLA (10 mol %), and filaments prepared from a blend of 220 kDa PLA containing 15 mol % 50 kDa PLA (15 mol %).

FIG. 4A is a photograph showing a t-peel sample prepared from 100% 220 kiloDalton (kDa) poly(lactic acid) (PLA) filaments after testing.

FIG. 4B is a photograph showing a t-peel sample prepared from filaments prepared from a blend of 220 kiloDalton (kDa) poly(lactic acid) (PLA) and 10 mole percentage (mol %) 50 kDa PLA after testing.

FIG. 5A is a graph showing maximum stress of tensile specimens as a function of low molecular weight (LMW) polymer loading in bimodal blends of 220 kiloDalton (kDa) poly(lactic acid) (PLA) and 8.5 kDa PLA used to make the filaments to produce the specimens. The amount of 8.5 kDa PLA used in the blend was 0 mole percentage (mol %), 3 mol %, or 10 mol %. Maximum stress in the specimens is shown in both the longitudinal (squares) and transverse (circles) directions.

FIG. 5B is a graph showing modulus (in gigapascals (GPa)) of tensile specimens as a function of low molecular weight (LMW) polymer loading in bimodal blends of 220 kiloDalton (kDa) poly(lactic acid) (PLA) and 8.5 kDa PLA used to make the filaments to produce the specimens. The amount of 8.5 kDa PLA used in the blend was 0 mole percentage (mol %), 3 mol %, or 10 mol %. Modulus in the specimens is shown in both the longitudinal (squares) and transverse (circles) directions.

FIG. 6A is a graph showing maximum stress of tensile specimens as a function of low molecular weight (LMW) polymer loading in bimodal blends of 220 kiloDalton (kDa) poly(lactic acid) (PLA) and 50 kDa PLA used to make the filaments to produce the specimens. The amount of 50 kDa PLA used in the blend was 0 mole percentage (mol %), 3 mol %, 10 mol %, or 15 mol %. Maximum stress in the specimens is shown in both the longitudinal (squares) and transverse (circles) directions.

FIG. 6B is a graph showing modulus (in gigapascals (GPa)) of tensile specimens as a function of low molecular weight (LMW) polymer loading in bimodal blends of 220 kiloDalton (kDa) poly(lactic acid) (PLA) and 50 kDa PLA used to make the filaments to produce the specimens. The amount of 50 kDa PLA used in the blend was 0 mole percentage (mol %), 3 mol %, 10 mol %, or 15 mol %. Modulus in the specimens is shown in both the longitudinal (squares) and transverse (circles) directions.

FIG. 7A is a graph showing maximum stress of tensile specimens as a function of low molecular weight (LMW) polymer loading in bimodal blends of 220 kiloDalton (kDa) poly(lactic acid) (PLA) and 100 kDa PLA used to make the filaments to produce the specimens. The amount of 100 kDa PLA used in the blend was 0 mole percentage (mol %), 3 mol %, 10 mol %, or 15 mol %. Maximum stress in the specimens is shown in both the longitudinal (squares) and transverse (circles) directions.

FIG. 7B is a graph showing modulus (in gigapascals (GPa)) of tensile specimens as a function of low molecular weight (LMW) polymer loading in bimodal blends of 220 kiloDalton (kDa) poly(lactic acid) (PLA) and 100 kDa PLA used to make the filaments to produce the specimens. The amount of 100 kDa PLA used in the blend was 0 mole percentage (mol %), 3 mol %, 10 mol %, or 15 mol %. Modulus in the specimens is shown in both the longitudinal (squares) and transverse (circles) directions.

FIG. 8 is a gel permeability chromatography (GPC) chromatograph of 100 kiloDalton (kDa) poly(lactic acid) (PLA) used as a low molecular weight additive in polymer blends according to some embodiments of the presently disclosed subject matter.

FIG. 9 is a differential scanning calorimetry (DSC) thermogram of a commercially available poly(lactic acid) (PLA) having a weight average molecular mass (M_{w}) of about 220 kiloDaltons (kDa) that was used as an exemplary high molecular weight (HMW) component of bimodal polymer blends for preparing filaments for fused deposition modeling.

FIG. 10 is a differential scanning calorimetry (DSC) thermogram of a poly(lactic acid) (PLA) having a weight average molecular mass (M_{w}) of about 50 kiloDaltons (kDa) that was used as an exemplary low molecular weight (LMW) additive of some embodiments of the bimodal polymer blends for preparing filaments for fused deposition modeling.

FIG. 11 is a bar graph of the crystallinity of extruded filaments made from blends of 220 kiloDalton (kDa) poly(lactic acid) (PLA) and 8.5 kDa PLA both before (black) and after (striped) printing from a print head for fused deposition modeling three-dimensional printing. The amount of 8.5 kDa PLA used in the blends was 0 mole percentage (mol %), 3 mol %, or 10 mol %. The polydispersity index (PDI) of the 8.5 kDa PLA is 1.4.

FIG. 12 is a bar graph of the crystallinity of extruded filaments made from blends of 220 kiloDalton (kDa) poly(lactic acid) (PLA) and 50 kDa PLA both before (black) and after (striped) printing from a print head for fused deposition modeling three-dimensional printing. The amount of 50 kDa PLA used in the blends was 0 mole percentage (mol %), 3 mol %, 10 mol %, or 15 mol %. The polydispersity index (PDI) of the 50 kDa PLA is 1.5.

FIG. 13 is a bar graph of the crystallinity of extruded filaments made from blends of 220 kiloDalton (kDa) poly(lactic acid) (PLA) and 100 kDa PLA both before (black) and after (striped) printing from a print head for fused deposition modeling three-dimensional printing. The amount of 100 kDa PLA used in the blends was 0 mole percentage (mol %), 3 mol %, 10 mol %, or 15 mol %. The polydispersity index (PDI) of the 100 kDa PLA is 4.3.

FIG. 14 is a schematic diagram of a fused deposition modelling three-dimensional printing process. A material spool loaded with polymer filament provides polymer filament to a heated extrusion head (i.e., a print head) that prints molten filament layer-by-layer on a platform. The heated extrusion head and platform can be controlled by a computer and a motor.

FIG. 15 is a schematic diagram showing the synthesis of poly(lactic acid) PLA for use as low molecular weight polymer additives.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. DEFINITIONS

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of temperature, time, concentration, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example±20% or ±10%, in another example±5%, in another example±1%, and in still another example±0.1% from the specified amount, as such variations are appropriate to perform the disclosed methods.

As used herein, a “monomer” refers to a molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units.

A “copolymer” refers to a polymer derived from more than one species of monomer. A “terpolymer” is a copolymer derived from three species of monomer.

As used herein, a “block macromolecule” refers to a macromolecule that comprises blocks in a linear sequence. A “block” refers to a portion of a macromolecule that has at least one feature that is not present in the adjacent portions of the macromolecule. A “block copolymer” refers to a copolymer in which adjacent blocks are constitutionally different, i.e., each of these blocks comprises constitutional units derived from different characteristic species of monomer or with different composition or sequence distribution of constitutional units.

For example, a diblock copolymer of polybutadiene and polystyrene is referred to as polybutadiene-block-polystyrene. Such a copolymer is referred to generically as an “AB block copolymer.” Likewise, a triblock copolymer can be represented as “ABA.” Other types of block polymers exist, such as multiblock copolymers of the (AB)ₙ type, ABC block polymers comprising three different blocks, and star block polymers, which have a central point with three or more arms, each of which is in the form of a block copolymer, usually of the AB type.

As used herein, a “graft macromolecule” or “graft polymer” refers to a macromolecule comprising one or more species of block connected to the main chain as a side chain or chains, wherein the side chain(s) comprises constitutional or configurational features that differ from those in the main chain. The term “multigraft copolymer” refers to a graft copolymer with at least two or more side chains (e.g., at least three, at least 5, or at least 10 side chains).

The term “blend” as used herein refers to a mixture of two or more polymers (i.e., a mixture of two or more separate (i.e., non-covalently bonded) macromolecules).

Polydispersity (PDI) refers to the ratio (M_{w}/Mₙ) of a polymer sample. M_{w} refers to the mass average molar mass (also commonly referred to as weight average molecular weight). Mₙ refers number average molar mass (also commonly referred to as number average molecular weight).

As used herein, the term “thermoplastic” refers a polymer or a composition comprising a polymer that softens or melts so as to become pliable, malleable, etc., when exposed to sufficient heat and generally returns to its original condition when cooled to room temperature.

As used herein, the term “filament” refers to a continuous length of material which has a thread-like structure, i.e., having a length which greatly exceeds its diameter. In some embodiments, the filament is intended for use in a fused deposition modeling process. A filament can be solid or fluid, e.g., when liquefied, molten, melted, and/or softened. In some embodiments, the filament can have an approximately circular diameter. In some embodiments, the diameter can be other than circular, e.g., oval, square, rectangular, triangular, hexagonal, another polygon shape, multi-lobed, or irregular.

As used herein, the term “three-dimensional (3D) printing” (also known as “additive printing” and “additive manufacturing”) can refer to any of various processes or techniques (e.g., coating, spraying, depositing, applying, extruding, fusing, sintering, or any combination thereof) for making a three-dimensional (3D) object (e.g., a device, a model, a component structure, a part, etc.), from a three-dimensional (3D) model and/or an electronic data source (e.g., computer assisted drawing (CAD) program file or stereolithographic (STL) file), through additive processes in which successive layers of material (e.g., filaments, films, powders, particles, and/or pellets) can be laid down, for example, under computer control. Three-dimensional (3D) printing processes, can include, but are not limited to, fused filament fabrication (FFF) or fused deposition modeling (FDM), selective laser sintering (SLS) (also referred to herein interchangeably as selective laser melting (SLM)), inkjet head 3D printing (also referred to herein interchangeably as inkjet 3D printing) and the like.

The term “colorants” as used herein refers to additive compositions or compounds, such as, but not limited to, pigments, dyes and tints, which impart color to a filament or a segment of a filament.

As used herein, the term “fillers” refers to additives which can alter a composition's mechanical properties, physical properties, chemical properties, electrical properties, magnetic properties, thermal properties, and/or appearance, and which can include, for example, one or more of: an oxide, (e.g., aluminum oxide, magnesium oxide, titanium oxide, an iron oxide (e.g., magnetic iron (III) oxide), indium-tin oxide (ITO), silicon oxide, or another metal oxide), hydrous magnesium silicate, alumina, calcium carbonate, carbon (e.g., diamond particles, carbon black, graphene), clay (e.g., clay platelets), chalk, boron carbide, chromium carbide, zirconium carbide, molybdenum carbide, tungsten carbide, titanium carbide, limestone, diatomaceous earth, mica, glass quartz, ceramic and/or glass microbeads, a metal fiber or particles, magnetic iron(III) oxide, silica, ceria, titania, titanium nitride, silicon nitride, carbon nanotubes, rods, whiskers and/or fibers, wood, cements, adhesives, gems, decorative elements, and the like.

As used herein, the term “plasticizer” can refer to an additive which can, for example, soften, make more flexible, malleable, pliable, and/or plastic a polymer or polymer composition, thus providing flexibility, pliability, and/or durability. Conventional plasticizers include, but are not limited to, tributyl citrate, acetyl tributyl citrate, diethyl phthalate, glycerol triacetate, glycerol tripropionate, triethyl citrate, acetyl triethyl citrate, phosphate esters (e.g., triphenyl phosphate, resorcinol bis(diphenyl phosphate), olicomeric phosphate, etc.), long chain fatty acid esters, aromatic sulfonamides, hydrocarbon processing oil, propylene glycol, epoxy-functionalized propylene glycol, polyethylene glycol, polypropylene glycol, partial fatty acid ester, glucose monoester, epoxidized soybean oil, acetylated coconut oil, linseed oil, epoxidized linseed oil, and the like.

As used herein, the term “improved isotropic properties” can refer to making the difference between the values of a particular tensile property of a 3D printed object when measured in the longitudinal and transverse directions (i.e. with respect to the printing direction of the filaments making up the object) smaller. Thus, an object with improved isotropic properties is an object wherein the difference between the value of a particular tensile property (e.g., modulus, strain at break, maximum stress, etc.) measured in the transverse direction and the value of that tensile property as measured in the longitudinal direction is smaller than the difference in an object of identical shape, but made from a filament prepared from a different polymeric composition. In some embodiments, the object with improved isotropic properties can have improved isotropy for more than one particular tensile property. In some embodiments, an object with improved isotropic properties can have modulus values measured in the longitudinal and transverse directions that differ by 0.05 GPa or less (e.g., 0.050, 0.045, 0.040, 0.035, 0.030, 0.025, or 0.020 GPa or less). In some embodiments, an object with improved isotropic properties can have stress at yield values measured in the longitudinal and transverse directions that differ by 20 MPa or less (e.g., 20, 19, 18, 17, 16, 15, or 14 MPa or less).

### II. GENERAL CONSIDERATIONS

In fused deposition modeling (FDM), a hot extruding end melts polymer onto a build platform in a xyz coordinate system. The model can be created via a computer assisted design program (CAD), and then sliced into layers which the printer reads. See Ahn et al., Rapid Prototyp. J., 8, 248-257 (2002). In a common set up, the printer controls a motor or motors which move a printer head (xy) or support bed (z) to build a 3D model layer by layer. See Bellini and Bucceri, Rapid Prototyp. J., 9, 252-264 (2003). While FDM is a very good tool for prototype modeling, a desire to expand the technique to build structural and functional parts has come with a number of problems.

More particularly, due to the stratified nature of the FDM process, the mechanical properties of the print can be dependent on the raster orientation. See Es-Said et al., Mater. Manuf. Process., 15, 107-122 (2000); Lee et al., J. Mater. Process. Technol., 169, 54-61 (2005); and Eastwood et al., Polymer, 46, 3957-3970 (2005). Tensile measurements show that when stress is applied with the filament (longitudinal), the modulus is significantly higher than when stress is applied perpendicular to the filament (transverse). See Lee et al., J. Mater. Process. Technol., 187-188, 627-630 (2007). Parts prepared by the FDM method can suffer from poor interfacial adhesion between layers which introduces anisotropic mechanical properties. See Ahn et al., Rapid Prototyp. J., 8, 248-257 (2002); Ziemian et al., “Anisotropic Mechanical Properties of ABS Parts Fabricated by Fused Deposition Modelling”, INTECH Open Access Publisher, 2012; and Shaffer et al., Polym. 55, 5969-5979 (2014). More particularly, significantly different mechanical properties can be observed with respect to the orientation of the printed part to the print head. See Bellehumeur et al., J. Manuf. Process., 6, 170-178 (2004). In the standard printed part, diffusion of polymer chains across the inter-filament interface is slow. See Acrawal et al., J. Polym. Science Part B: Polymer Physics, 34, 2919-2940 (1996); and Wool et al., Am. Chem. Soc., Polym. Prepr. Div. Polym. Chem., 28, 38-39 (1987). Poor diffusion across the interface leads to less entanglement of chains between layers and poor interlayer adhesion.

Small polymer chains can diffuse more readily than their large counterparts. Additionally, it can be entropically favorable for these small chains to preferentially migrate to an interface, such as the outer surface of a filament. See Schonhorn, J. Phys. Chem., 1084-1085 (1965); Homma et al., IEEE Trans. Dielectr. Electr. Insul., 6, 370-375 (1999); Scalettar et al., Proc. Natl. Acad. Sci. USA, 85, 6726-6730 (1988); and Demarquette et al., J. Appl. Polym. Sci., 83, 2201-2212 (2002).

### II.A. POLYMER BLENDS

The presently disclosed subject matter provides, in some embodiments, a composition comprising a blend of polymers of two different molecular weights that can be used to prepare building materials for 3D printing. Building materials and/or 3D printed objects with desired properties can be provided by tailoring the molecular weights and/or mixing ratios of the individual polymers in the blends.

According to an aspect of the presently disclosed subject matter, bimodal polymer blends are provided that incorporate a smaller polymer chain, usually of the same chemical type and/or comprising an identical monomeric unit or units, to the polymer used to prepare filament for FDM. Under the same printing conditions of the neat printed samples, the presence of the low molecular weight (LMW) chains improve entanglement across layers as they more readily diffuse across the filament interface. If the LMW chains are of a sufficient length, chain entanglement between layers increases. Thus, an improvement in inter-filament adhesion and a more isotropic printed part can result.

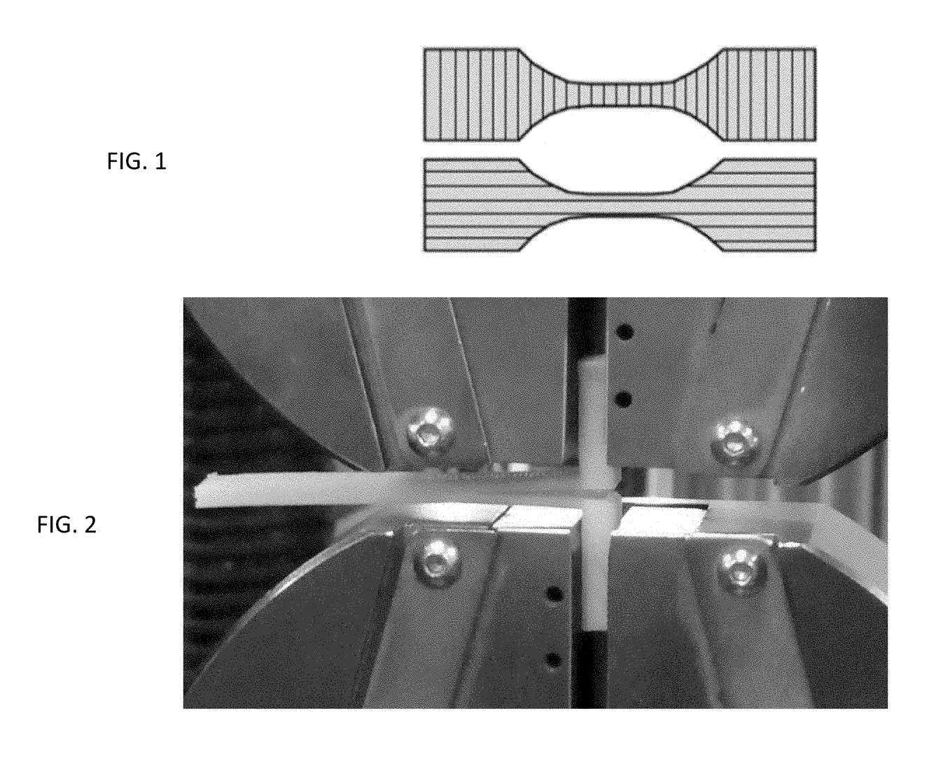

In the examples provided below, a model polymer blend is tested by 3D printing filament prepared from a polymer blend created by the addition various amounts of a poly(lactide) (PLA) synthesized at different low molecular weights to a higher molecular weight commercially available PLA. Comparing the M_{w}s of samples taken from surface regions of the filaments to M_{w}s of samples from interior (center) regions of the filaments indicated that the LMW PLA additive migrates preferentially to the outer regions of the filament. Tensile specimens prepared in both the longitudinal and transverse orientations, as shown in FIG. 1, are used to quantify the improvement of the interfacial adhesion and the structural isotropy of the sample. These examples showed that, with the proper molecular weight and loading of the additive, a significant improvement in interfacial adhesion is obtained.

In some embodiments, the presently disclosed subject matter provides a polymer blend comprising a high molecular weight (HMW) thermoplastic polymer and a LMW thermoplastic polymer. Typically, the major component (i.e., at least 50% by weight) of the blend is the HMW polymer. Thus, the LMW polymer can also be viewed as an additive. In some embodiments, the blend comprises between about 0.5 weight % (wt %) and about 15 wt % of the LMW polymer (i.e., about 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, or 15.0 wt %). In some embodiments, the blend comprises between 0.5 wt % and about 5 wt % of the LMW thermoplastic polymer.

Any suitable thermoplastic polymer or mixture of polymers can be used as the HMW polymer and as the LMW polymer so long as the HMW polymer and the LMW polymer as sufficiently miscible (i.e., such that the HMW polymer and low molecular weight polymer provide a relatively homogeneous blend when melted and/or where either the LMW or HMW polymer does not precipitate out of a melt of the blend). In some embodiments, the change in Gibbs free energy upon mixing (ΔGₘ) of the two polymers is less than 0. Typically the HMW polymer and the LMW polymer are polymers of the same chemical type (i.e., they are polymerized from the monomers comprising the same type of polymerizable group) and/or contain side chains that have similar chemical groups or chemical groups that can interact (e.g., aromatic side chains or hydrogen bonding side chains (e.g., hydroxyl and/or carboxylic acid side chains)).

Suitable thermoplastic polymers include, but are not limited to, a polyolefin (PO), such as polyethylene (PE), polypropylene (PP), polybutene, ethylene propylene rubber (EPR), polyoxyethylene (POE), cyclic olefin copolymer (COC), or combinations thereof; a polystyrene homopolymer or copolymer, such as polystyrene (PS), poly(α-methylstyrene), ABS, styrene acrylonitrile (SAN), styrene butadiene rubber (SBR or HIPS), styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof; a thermoplastic polyurethane (TPU); a polyamide, such as polyamide 6,6 (PA66), polyamide 1,1 (PA11), polyamide 1,2 (PA12), a copolyamide (COPA), or combinations thereof; an acrylic polymer, such as polymethyl acrylate, polymethylmethacrylate, a methyl methacrylate styrene (MS) copolymer, or combinations thereof; a polyvinylchloride (PVC), a chlorinated polyvinylchloride (CPVC), or combinations thereof; a polyoxyemethylene, such as polyacetal; a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), PLA, polyglycolic acid (PGA), copolymers of PLA and PGA, or combinations thereof; a polycarbonate (PC); a polyphenylene sulfide (PPS); a polyphenylene oxide (PPO); or combinations thereof. In some embodiments, the thermoplastic polymer is not a polyolefin or an acrylic polymer.

In some embodiments, the HMW thermoplastic polymer and/or the LMW thermoplastic polymer are each independently selected from the group comprising PLA, ABS, a polyetherimide (PEI), polyethyl ether ketone (PEEK), a polyether ketone ketone (PEKK), a PS, polyphenylsulfone (PPSF), glycol-modified polyethylene terephthalate (PETG), a polyester, a polyamide (PA), and PC. In some embodiments, the HMW polymer and/or the LMW polymer is ABS or PLA. In some embodiments, the HMW thermoplastic polymer and the LMW thermoplastic polymer are polymers derived from the polymerization of at least one of the same monomers. In some embodiments, the HMW thermoplastic polymer is ABS and the LMW thermoplastic polymer is PS.

In some embodiments, the HMW thermoplastic polymer and the LMW thermoplastic polymer are derived from the polymerization of the same monomer or monomers. In some embodiments, the HMW thermoplastic polymer and the LMW thermoplastic polymer are both PLA.

The HMW polymer typically has a M_{w} that is at least two times greater than the M_{w} of the LMW polymer. In some embodiments, the M_{w} of the HMW thermoplastic polymer is four to eight times greater (i.e., four, five, six, seven or eight times greater) than the M_{w} of the LMW thermoplastic polymer. In some embodiments, the LMW thermoplastic polymer has a M_{w} that is greater than the entanglement molecular weight (Mₑ) of the thermoplastic polymer but about half or less than half of the M_{w} of the HMW thermoplastic polymer. The Mₑ for a particular polymer can be determined via methods known in the art. See, e.g., Fetters et al., “Chain Dimensions and Entanglement Spacing” in Physical Properties of Polymers Handbook; James E. Mark, Ed.; Springer (NY) 2007.

In some embodiments, the HMW polymer has a M_{w} of at least about 200,000 g/mol. In some embodiments, the LMW thermoplastic polymer has a Mw of between about 25,000 g/mol and about 100,000 g/mol (e.g., about 25,000; about 30,000; about 35,000; about 40,000; about 45,000; about 50,000; about 55,000; about 60,000; about 65,000; about 70,000; about 75,000; about 80,000; about 85,000; about 90,000; about 95,000; or about 100,000 g/mol). In some embodiments, the LMW thermoplastic polymer has a M_{w} of about 50,000 g/mol.

In some embodiments, the LMW thermoplastic polymer comprises between about 3 mole percentage (mol %) and about 15 mol % of the blend (i.e., about 3, 4, 5, 6, 7, 8, 9, 10, 11, 12, 13, 14, or 15 mol %) of the blend. In some embodiments, the LMW and HMW polymers are both PLA, the HMW polymer has a M_{w} or about 220,000, the LMW thermoplastic polymer has a M_{w} of about 50,000 g/mol and comprises about 10 mol % of the blend.

In some embodiments, the blend has a polydispersity index (PDI) of between about 2.1 and about 3.0 (e.g., about 2.1, 2.2, 2.3, 2.4, 2.5, 2.6, 2.7, 2.8, 2.9, or about 3.0).

### II.B. POLYMER FILAMENTS

In some embodiments, the presently disclosed subject matter provides a filament comprising/prepared from a polymer blend comprising at least two polymers of different molecular weights. In some embodiments, the filament is prepared from a polymer blend comprising: (a) a HMW thermoplastic polymer, and (b) a LMW thermoplastic polymer; wherein the HMW thermoplastic polymer has a M_{w} that is at least two times greater than the M_{w} of the LMW thermoplastic polymer. Typically, the major component of the blend is the HMW polymer. Thus, the LMW polymer can also be viewed as an additive. In some embodiments, the blend comprises between about 0.5 wt % and about 15 wt % of the LMW polymer (i.e., about 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, or 15.0 wt %). In some embodiments, the blend comprises between 0.5 wt % and about 5 wt % of the LMW thermoplastic polymer.

Any suitable thermoplastic polymer or mixture of polymers can be used as the HMW polymer and as the LMW polymer so long as the HMW polymer and the LMW polymer as sufficiently miscible. Suitable thermoplastic polymers include, but are not limited to, the thermoplastic polymers listed above. In some embodiments, the thermoplastic polymer is not a polyolefin or an acrylic polymer. In some embodiments, the HMW thermoplastic polymer and/or the LMW thermoplastic polymer are each independently selected from the group comprising PLA, ABS, a PEI, PEEK, a PEKK, a PS, PPSF, PETG, a polyester, a PA, and PC. In some embodiments, the HMW polymer and/or the LMW polymer is ABS or PLA. In some embodiments, the HMW thermoplastic polymer and the LMW thermoplastic polymer are polymers derived from the polymerization of at least one of the same monomers. In some embodiments, the HMW thermoplastic polymer is ABS and the LMW thermoplastic polymer is PS.

In some embodiments, the HMW thermoplastic polymer and the LMW thermoplastic polymer are derived from the polymerization of the same monomer or monomers. In some embodiments, the HMW thermoplastic polymer and the LMW thermoplastic polymer are both PLA.

In some embodiments, the M_{w} of the HMW thermoplastic polymer is four to eight times greater (i.e., four, five, six, seven or eight times greater) than the M_{w} of the LMW thermoplastic polymer. In some embodiments, the LMW thermoplastic polymer has a M_{w} that is greater than the entanglement molecular weight (Mₑ) of the thermoplastic polymer but about half or less than half of the M_{w} of the HMW thermoplastic polymer.

In some embodiments, the HMW polymer has a M_{w} of at least about 200,000 g/mol. In some embodiments, the LMW thermoplastic polymer has a Mw of between about 25,000 g/mol and about 100,000 g/mol (e.g., about 25,000; about 30,000; about 35,000; about 40,000; about 45,000; about 50,000; about 55,000; about 60,000; about 65,000; about 70,000; about 75,000; about 80,000; about 85,000; about 90,000; about 95,000; or about 100,000 g/mol). In some embodiments, the LMW thermoplastic polymer has a M_{w} of about 50,000 g/mol.

In some embodiments, the LMW thermoplastic polymer comprises between about 3 mole percentage (mol %) and about 15 mol % of the blend (i.e., about 3, 4, 5, 6, 7, 8, 9, 10, 11, 12, 13, 14, or 15 mol %) of the blend. In some embodiments, the LMW and HMW polymers are both PLA, the HMW polymer has a M_{w} or about 220,000, the LMW thermoplastic polymer has a M_{w} of about 50,000 g/mol and comprises about 10 mol % of the blend.

In some embodiments, the blend has a polydispersity index (PDI) of between about 2.1 and about 3.0 (e.g., about 2.1, 2.2, 2.3, 2.4, 2.5, 2.6, 2.7, 2.8, 2.9, or about 3.0).

In some embodiments, the polymer blend can also include an additional additive (i.e., other than the LMW thermoplastic polymer). The additional additives can include, but are not limited to, pigments, dyes, or other colorants, color stabilizers, UV stabilizers, UV absorbers, antioxidants, lubricity agents, heat stabilizers, hydrolysis stabilizers, cross-linking activators, flame retardants (e.g., a polytetrafluoroethylene (PTFE) polymer, a boron phosphate flame retardant, a magnesium oxide, a dipentaerythritol, etc.), layered silicates, organic or inorganic fillers, reinforcing agents, adhesion mediators, impact strength modifiers, antimicrobials, and any combination thereof. These additional additives can be included in an amount typically used in the art and/or sufficient to provide a desired effect.

The presently disclosed filaments can be prepared by providing the HMW polymer, the LMW polymer and any desired additives and preparing a mixture of the components in desired amounts. The mixing can be performed manually or mechanically. Then the mixture can be heated to provide a melt. The temperature of the melt can depend upon the melt temperatures of the particular HMW and LMW polymers used. In some embodiments, e.g., when the HMW and LMW polymers are each PLA, the polymer mixture is heated to between about 160° C. and about 165° C. The melt can then be extruded from a a single or double screw extruder to provide a filament having a desired diameter.

### II.C. THREE-DIMENSIONAL OBJECTS COMPRISING FILAMENTS FROM POLYMER BLENDS

In some embodiments, the presently disclosed subject matter provides a three-dimensional object comprising a plurality of adjacent layers of a filament as described above or prepared using a melt of the polymer blend described above (e.g., such that the three-dimensional object is prepared from a plurality of droplets of a melt of the disclosed polymer blends). Due to increased interfacial adhesion of the filaments (or droplets), the presently disclosed objects can have improved isotropic properties compared to an object of the same design prepared from a filament comprising no LMW thermoplastic polymer. Thus, in some embodiments, the presently disclosed objects can find use a structural components, in addition to use a prototypes and/or models.

The increase in isotropy can relate to a decrease in the difference between the value measured in the transverse direction and value measured in the longitudinal direction of one particular tensile property or decreases in the differences between values of multiple tensile properties as measured in transverse and longitudinal direction. In some embodiments, the object can have a difference between modulus measured in the transverse direction and modulus measured in the longitudinal direction of about 0.05 GPa or less (e.g., about 0.050, 0.045, 0.040, 0.035, 0.030, 0.025, 0.020, 0.015, or 0.010 GPa or less). In some embodiments, the difference is about 0.02 GPa or less. In some embodiments, the object can have a difference between stress at yield (or maximum stress) measured in the transverse direction and stress at yield (or maximum stress) measured in the longitudinal direction of about 20 MPa or less (e.g., about 20, 19, 18, 17, 16, 15, or 14 MPa or less). In some embodiments, the difference is about 19 MPa or less. In some embodiments, the difference is about 15 MPa or less.

In some embodiments, in addition to the object having improved isotropy compared to the same object made from a filament that did not include the LMW polymer, the object can also have show improvement in one or more tensile properties. For example, the object can have one or more of higher maximum stress in the longitudinal direction, higher maximum stress in the transverse direction, higher modulus in the longitudinal direction, higher modulus in the transverse direction, and higher toughness (i.e., greater area under the curve for a stress/strain curve) compared to an object of the same design prepared from a filament comprising no LMW thermoplastic polymer. In some embodiments, the maximum stress in the transverse direction is at least 5% greater (e.g., at least 5%, 10%, 15%, 20%, 25%, 30%, or 35% greater) than in an object of the same design prepared from a filament comprising no LMW thermoplastic polymer. In some embodiments, the maximum stress in the transverse direction is at least 40% greater (e.g., at least 40%, 50%, or 60% greater) than in an object of the same design prepared from a filament comprising no LMW thermoplastic polymer. In some embodiments, the modulus in the transverse direction is at least 10%, 15%, 20%, or 25% greater than in an object of the same design prepared from a filament comprising no LMW thermoplastic polymer.

The three-dimensional objects of the presently disclosed subject matter can include three-dimensional objects of any desired shape or size. In some embodiments, the three-dimensional object is a medical implant, an automotive body panel, an automotive frame, a container, a wall of a structure, a piece of furniture, or an aerospace bracket.

### II.D. METHODS OF PREPARING THREE-DIMENSIONAL OBJECTS AND IMPROVING THE ISOTROPY THEREOF

In some embodiments, the presently disclosed subject matter provides a method of preparing a three-dimensional object using a polymer blend and/or filament as described above. In some embodiments, the three-dimensional object is prepared via a FDM process. The fused deposition modeling (FDM) process builds objects layer-by-layer by heating a building material (e.g., a polymeric blend and/or filament) to a semi-liquid state and extruding it according to computer-controlled paths. The material can be dispensed as a semi-continuous flow and/or filament of material from the dispenser or it can alternatively be dispensed as individual droplets. Two or more different building materials can be used to complete the build of an object.

A building material or materials is used to constitute the finished object. A support material can also be used to act as scaffolding for the building material. In some embodiments, building material filaments can be fed to a print/extrusion head/nozzle, which can be heated and which typically moves in a two dimensional plane, depositing material to complete each layer before a base or support platform upon which the object is being built (or the print head/nozzle) moves along a third axis to a new level and/or plane and the next layer begins. Once the building is complete, the user can remove the support material, leaving an object that is ready to use.

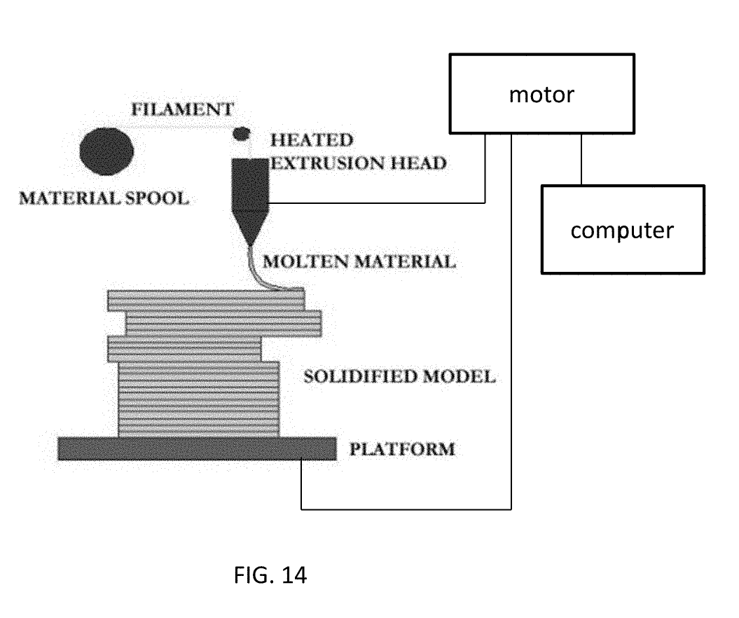

FIG. 14, for instance, shows a schematic diagram of a FDM method where polymeric filament from a material spool is fed into a heated extrusion head (which is moveable along at least the x and y axis) and layers of the heated, molten filament are extruded layer-by-layer on a support platform (which can be moveable along the z axis. As the method proceeds, previously printed layers, which are at least partially in contact with one another, solidify to form the 3D object. In some embodiments, the support platform can be heated. The movement of the extrusion head and/or the support platform can be controlled by a motor, which can be controlled by a computer.

Accordingly, in some embodiments, the presently disclosed subject matter provides a method of preparing a three-dimensional object, wherein the method comprises: (i) providing a filament prepared from a polymer blend comprising a HMW thermoplastic polymer and a LMW thermoplastic polymer; (ii) heating the filament; and (iii) dispensing heated filament to form a plurality of adjacent layers of dispensed filament, thereby preparing the three-dimensional object. In some embodiments, the dispensing of step (iii) comprises: (1) dispensing heated filament from a print head while moving the print head in a first two dimensional plane to form a first layer of dispensed filament on a support surface; (2) moving the print head or support surface in a direction perpendicular to the first two dimensional plane; (3) dispensing heated filament from the print head while moving the print head in a second two dimensional plane, wherein the second two dimensional plane is parallel to the two dimensional plane of step (1) to form a second layer of dispensed filament, wherein a least a portion of the second layer is in contact with the first layer; and (4) repeating the moving of the print head or support surface and the dispensing of heated filament to form one or more additional layers layer-by-layer, wherein each of the additional layers is in contact with at least a portion of the adjacent layer or layers. In some embodiments, the movement of the print head and/or the support surface is controlled by a motor and/or computer.

Typically, the major component of the blend is the HMW polymer. Thus, the LMW polymer can also be viewed as an additive. In some embodiments, the blend comprises between about 0.5 wt % and about 15 wt % of the LMW polymer (i.e., about 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, or 15.0 wt %). In some embodiments, the blend comprises between 0.5 wt % and about 5 wt % of the LMW thermoplastic polymer.

Any suitable thermoplastic polymer or mixture of polymers can be used as the HMW polymer and as the LMW polymer so long as the HMW polymer and the LMW polymer as sufficiently miscible. Typically the HMW polymer and the LMW polymer are polymers of the same chemical type (i.e., they are polymerized from the same type of monomers) and/or contain similar chemical groups (e.g., aromatic side chains or carboxylic acid side chains). Suitable thermoplastic polymers include, but are not limited to, the thermoplastic polymers listed above. In some embodiments, the thermoplastic polymer is not a polyolefin or an acrylic polymer. In some embodiments, the HMW thermoplastic polymer and/or the LMW thermoplastic polymer are each independently selected from the group comprising PLA, ABS, a PEI, PEEK, a PEKK, a PS, PPSF, PETG, a polyester, a PA, and PC. In some embodiments, the HMW polymer and/or the LMW polymer is ABS or PLA. In some embodiments, the HMW thermoplastic polymer and the LMW thermoplastic polymer are polymers derived from the polymerization of at least one of the same monomers. In some embodiments, the HMW thermoplastic polymer is ABS and the LMW thermoplastic polymer is PS.

In some embodiments, the HMW thermoplastic polymer and the LMW thermoplastic polymer are derived from the polymerization of the same monomer or group of monomers. In some embodiments, the HMW thermoplastic polymer and the LMW thermoplastic polymer are both PLA.

The HMW polymer typically has a M_{w} that is at least two times greater than the M_{w} of the LMW polymer. In some embodiments, the M_{w} of the HMW thermoplastic polymer is four to eight times greater (i.e., four, five, six, seven or eight times greater) than the M_{w} of the LMW thermoplastic polymer. In some embodiments, the LMW thermoplastic polymer has a M_{w} that is greater than the entanglement molecular weight (Mₑ) of the thermoplastic polymer but about half or less than half of the M_{w} of the HMW thermoplastic polymer.

In some embodiments, the HMW polymer has a M_{w} of at least about 200,000 g/mol. In some embodiments, the LMW thermoplastic polymer has a Mw of between about 25,000 g/mol and about 100,000 g/mol (e.g., about 25,000; about 30,000; about 35,000; about 40,000; about 45,000; about 50,000; about 55,000; about 60,000; about 65,000; about 70,000; about 75,000; about 80,000; about 85,000; about 90,000; about 95,000; or about 100,000 g/mol). In some embodiments, the LMW thermoplastic polymer has a M_{w} of about 50,000 g/mol.

In some embodiments, the LMW thermoplastic polymer comprises between about 3 mol % and about 15 mol % of the blend (i.e., about 3, 4, 5, 6, 7, 8, 9, 10, 11, 12, 13, 14, or 15 mol %) of the blend. In some embodiments, the LMW and HMW polymers are both PLA, the HMW polymer has a M_{w} or about 220,000, the LMW thermoplastic polymer has a M_{w} of about 50,000 g/mol and comprises about 10 mol % of the blend.

In some embodiments, the blend has a polydispersity index (PDI) of between about 2.1 and about 3.0 (e.g., about 2.1, 2.2, 2.3, 2.4, 2.5, 2.6, 2.7, 2.8, 2.9, or about 3.0). In some embodiments, the polymer blend can include an additional additive (i.e., other than the LMW thermoplastic polymer).

In some embodiments, the presently disclosed subject matter provides a method of improving the isotropy of an object prepared via a FDM 3D printing process, wherein the method comprises adding a LMW polymer (i.e., a LMW thermoplastic polymer) to a HMW polymer (i.e., a HMW thermoplastic polymer) to provide a bimodal polymer blend for use in preparing a building material for the object. The addition of the LMW polymer can improve polymer entanglement across layers, which can improve interfacial adhesion between layers of building material within the object. In some embodiments, the object can have a difference between modulus measured in the transverse direction and modulus measured in the longitudinal direction of about 0.05 GPa or less (e.g., about 0.050, 0.045, 0.040, 0.035, 0.030, 0.025, 0.020, 0.015, or 0.010 GPa or less). In some embodiments, the difference is about 0.02 GPa or less. In some embodiments, the object can have a difference between stress at yield (or maximum stress) measured in the transverse direction and stress at yield (or maximum stress) measured in the longitudinal direction of about 20 MPa or less (e.g., about 20, 19, 18, 17, 16, 15, or 14 MPa or less). In some embodiments, the difference is about 19 MPa or less. In some embodiments, the difference is about 15 MPa or less. In some embodiments, improving the isotropy of the object by incorporation of a LMW polymer can also result in improvement in one or more tensile properties (e.g., modulus, maximum stress, and/or toughness) of the object as compared to an object of the same geometry prepared without the LMW polymer.

In some embodiments, the bimodal polymer blend comprises between about 0.5 wt % and about 15 wt % of the LMW polymer (i.e., about 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, or 15.0 wt %). In some embodiments, the blend comprises between 0.5 wt % and about 5 wt % of the LMW thermoplastic polymer.

Any suitable thermoplastic polymer or mixture of polymers can be used as the HMW polymer and as the LMW polymer so long as the HMW polymer and the LMW polymer as sufficiently miscible. Suitable thermoplastic polymers include, but are not limited to, the thermoplastic polymers listed above. In some embodiments, the thermoplastic polymer is not a polyolefin or an acrylic polymer. In some embodiments, the HMW thermoplastic polymer and/or the LMW thermoplastic polymer are each independently selected from the group comprising PLA, ABS, a PEI, PEEK, a PEKK, a PS, PPSF, PETG, a polyester, a PA, and PC. In some embodiments, the HMW polymer and/or the LMW polymer is ABS or PLA. In some embodiments, the HMW thermoplastic polymer and the LMW thermoplastic polymer are polymers derived from the polymerization of at least one of the same monomers. In some embodiments, the HMW thermoplastic polymer is ABS and the LMW thermoplastic polymer is PS. In some embodiments, the HMW thermoplastic polymer and the LMW thermoplastic polymer are derived from the polymerization of the same monomer or monomers. In some embodiments, the HMW thermoplastic polymer and the LMW thermoplastic polymer are both PLA.

The HMW polymer typically has a M_{w} that is at least two times greater than the M_{w} of the LMW polymer. In some embodiments, the M_{w} of the HMW thermoplastic polymer is four to eight times greater (i.e., four, five, six, seven or eight times greater) than the M_{w} of the LMW thermoplastic polymer. In some embodiments, the LMW thermoplastic polymer has a M_{w} that is greater than the Mₑ of the thermoplastic polymer but about half or less than half of the M_{w} of the HMW thermoplastic polymer.

In some embodiments, the HMW polymer has a M_{w} of at least about 200,000 g/mol. In some embodiments, the LMW thermoplastic polymer has a Mw of between about 25,000 g/mol and about 100,000 g/mol (e.g., about 25,000; about 30,000; about 35,000; about 40,000; about 45,000; about 50,000; about 55,000; about 60,000; about 65,000; about 70,000; about 75,000; about 80,000; about 85,000; about 90,000; about 95,000; or about 100,000 g/mol). In some embodiments, the LMW thermoplastic polymer has a M_{w} of about 50,000 g/mol.

In some embodiments, the LMW thermoplastic polymer comprises between about 3 mol % and about 15 mol % of the blend (i.e., about 3, 4, 5, 6, 7, 8, 9, 10, 11, 12, 13, 14, or 15 mol %) of the blend. In some embodiments, the LMW and HMW polymers are both PLA, the HMW polymer has a M_{w} or about 220,000, the LMW thermoplastic polymer has a M_{w} of about 50,000 g/mol and comprises about 10 mol % of the blend. In some embodiments, the blend has a polydispersity index (PDI) of between about 2.1 and about 3.0 (e.g., about 2.1, 2.2, 2.3, 2.4, 2.5, 2.6, 2.7, 2.8, 2.9, or about 3.0). In some embodiments, the polymer blend can include an additional additive (i.e., other than the LMW thermoplastic polymer).

### III. EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Synthesis of Low Molecular Weight Poly(Lactic Acids) and Preparation of Bimodal Polymer Blends

Materials:

Poly(lactide) pellets (4043D, Filabot, Barre, Vt., United States of America), DL-lactide (DL-LA), isopropanol (iPrOH), and toluene (Thermo Fisher Scientific, Waltham, Mass., Unites States of America), as well as Stannous Octoate (Sn(Oct)₂, Sigma Aldrich, St. Louis, Mo., United States of America) were used as received. All glassware and magnetic stirrers were stored in an oven at 110° C. and cooled before reaction.

Synthesis of 50 k Low Molecular Weight Poly(Lactide) (PLA):

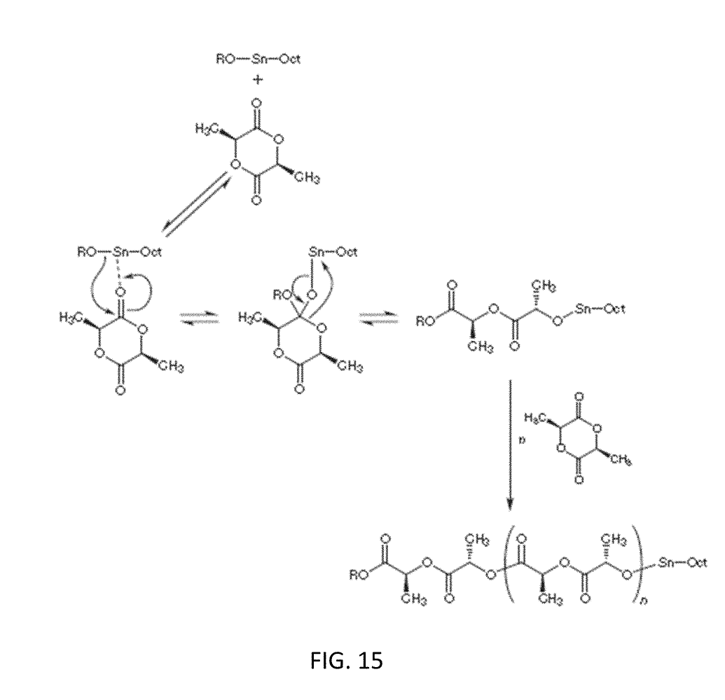

LMW PLAs were synthesized as shown in FIG. 15. More particularly, to prepare a 50 k LMW PLA, to a 2-neck round bottom flask was added 12.6330 g of DL-LA, 30 μL iPrOH, 141 μL Sn(Oct)₂, and 30 mL of Toluene. The reaction vessel was equipped with a condenser and purged under nitrogen for 5 minutes and the reaction was refluxed under N₂ atmosphere for 4 hours. The resulting PLA was precipitated into cold, stirring hexanes and redissolved into methylene chloride. Methylene chloride was evaporated and PLA dried at 90° C. under vacuum for 24 hrs prior to use. 8.5 kDa and 100 kDa PLA molecular weights were prepared analogously. Molecular weight characterization was performed by gel permeation chromatography (GPC) on a Tosoh EcoSEC chromatograph (Tosoh, Tokyo, Japan) equipped with a refractive index (RI) detector. All molecular weights are presented relative to a calibrated polystyrene standard.

Preparation of Bimodal PLA Blends:

4043D pellets and low molecular weight (LMW) synthesized PLA were dried under vacuum prior to use. Blends were prepared by mechanical mixing in a Filabot Original single screw extruder (Filabot, Barre, Vt., United States of America). Filament was extruded at 160-165° C., depending upon LMW added, to a diameter of 2.85+/−0.1 mm.

### Example 2

### FDM and Tensile Samples

ASTM D638-V Tensile Specimens:

All tensile specimens were cut from a cube that was printed by FDM on a LULZBOT™ TAZ 5 3D printer (Aleph Objects, Inc., Loveland, Colo., United States of America) with a 0.5 mm nozzle. The extruder nozzle was heated to 190° C. and the build platform heated to 70° C. The specimens were cut into dogbones from a printed cube such that half the dogbones were cut perpendicular to the print surface yielding the transverse orientation and the other half cut parallel to the print surface yielding the longitudinal orientation. See FIG. 1. Upon cutting the samples into dogbones, the tensile properties were determined on an INSTRON™ universal testing machine (Illinois Tool Works Inc. Corporation, Glenview, Ill., United States of America) equipped with a 100 kN load cell and wedge action grips. Tensile measurements were carried out at an extension rate of 1.00 mm/min with 20% sensitivity.

Discussion:

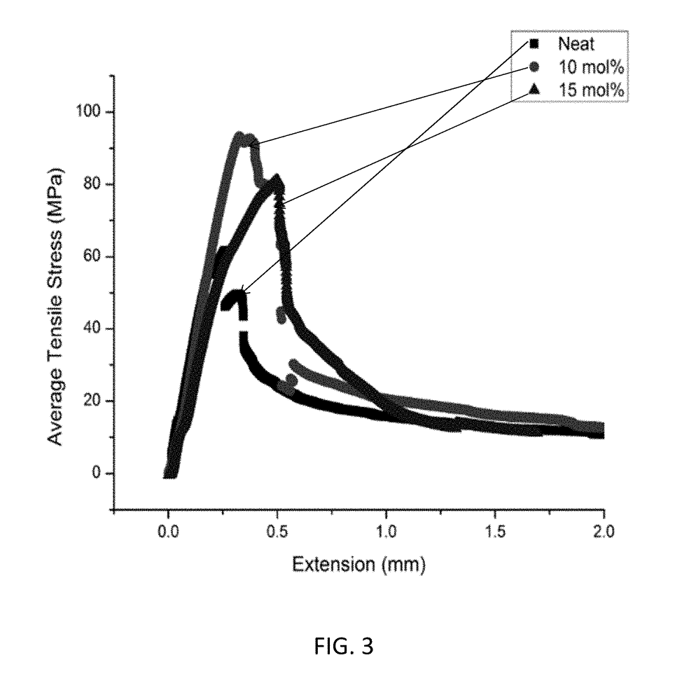

To directly monitor inter-layer adhesion between filaments, and quantify the extent to which the addition of the low molecular weight additive improves the strength of these interfaces, a protocol was designed utilized to monitor inter-layer adhesion in 3D printed samples. This protocol is based on the ASTM T-Peel standard (ASTM D638-V), and involves 3D printing the T-Peel specimens and determining the interfacial adhesion between layers using an INSTRON™ universal testing machine (Illinois Tool Works Inc. Corporation, Glenview, Ill., United States of America) as shown in FIG. 2. An intentional notch is placed at the interface of two layers to begin crack formation. Tensile stress is measured as a function of extension where the layer strength is determined as the average stress once the stress curve reaches a minimum. See FIG. 3. Furthermore, a value for interfacial adhesion (Gₐ) is calculated using the following equation:

$${G}_{a} = \frac{F}{W}$$

where F is the force required to separate the layers and W is the width of the layer in meters. In this way, layer adhesion was monitored from the peel test of the interlayer interface.

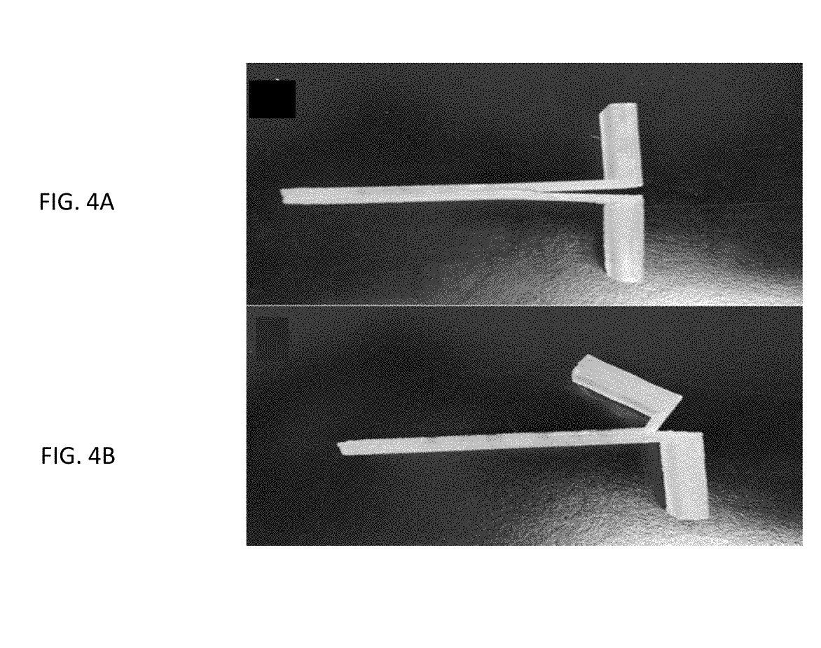

Initial studies were completed for a sample prepared from neat filament comprising 220 kDa M_{w} PLA, as well as samples prepared from bimodal filaments comprising the parent 220 kDa PLA and a 50 kDa Mw PLA at loadings of 10 and 15 mol %. In the neat samples, failure propagated along the interface (see FIG. 4A), resulting in an interfacial strength of approximately 15 MPa. Without being bound to any one theory, this appears to indicate a weak interface where diffusion and entanglement of polymer chains across the inter-layer interface is poor. In the 10 mol % blend samples, the crack formation did not propagate along the interface and instead was redirected into adjacent layers as seen in FIG. 4B. While this behavior prevents assigning a quantitative value to the interfacial strength in these samples, it is an indication of a dramatic improvement in the interfacial adhesion. It suggests that upon addition of the LMW additive, layer adhesion becomes significantly enhanced such that the path of least resistance is not along the interface, as in the neat samples, and therefore crack propagation transfers into adjacent layers. To explain this improvement (and without being bound to any one theory), it would seem that the LMW additive enhances layer adhesion through an increase in diffusion and entanglement of chains across the inter-layer interface. The 15 mol % samples behaved in the same manner as the 10 mol % samples and crack propagation transferred into adjacent layers. Additionally, as shown in FIG. 3, the maximum stress for the 10 and 15 mol % samples are significantly higher than the neat sample (i.e., the 100% HMW sample) indicating more force was required to initiate the crack even with the intentional starting notch. These results provide qualitative evidence that the LMW additive substantially improves the interfacial adhesion of a 3D printed sample.

Samples were manually taken from the outer surfaces of filaments prepared from a blend comprising 3 wt % of a 50,000 g/mol LMW polymer, as well as from the center of the filaments to determine whether LMW polymer was preferentially migrating to the outer surface of the filaments. Mₙ, M_{w} and PDI were determined for each of the samples. Results are provided in Table 1, below. The data is consistent with migration of the LMW material to the outside edge of the filament.

TABLE 1
Molecular Weight Distribution in Filament

| Sample | Mn (g/mol) | Mw (g/mol) | PDI |
|---|---|---|---|
| Whole filament | 58,062 | 151,598 | 2.611 |
| Outside | 64,095 | 149,762 | 2.337 |
| Center | 62,034 | 156,287 | 2.519 |

To better quantify the tensile properties, bimodal blends comprising the parent 220 kDa PLA and one of three molecular weights of LMW additive (8.5 kDa, 50 kDa, or 100 kDa) were prepared at loadings of 3, 10, and 15 mol %. Table 2, below, summarizes the molecular weight distributions of the PLA samples used in these studies. The large polydispersity (PDI) of the 100 kDa series provides a comparison of the effect of a narrow vs. broad PDI to the sample properties. The 8.5 kDa series was selected because it is at the entanglement weight, Mₑ, of PLA. See Dorgan et al., J. Rheol., 43, 1141 (1999). At this molecular weight, the diffusion of the polymer is fastest, yet chain entanglement can begin to decrease. Tensile bars that follow the ASTM standard were prepared from the printed cube by cutting the dogbones such that the direction of applied stress is in the longitudinal and transverse orientation relative to the filament. See FIG. 1. To maintain a statistical average, six specimens were prepared for each molecular weight and loading.

TABLE 2
Molecular weight distributions for the LMW PLA additives

| LMW sample | Mₙ (×10³) | M_{w} (×10³) | PDI |
|---|---|---|---|
| 8.5 kDa | 5.9 | 8.5 | 1.4 |
| 50 kDa | 35.6 | 54.3 | 1.5 |
| 100 kDa | 24.2 | 104.5 | 4.3 |

Table 3, below, illustrates the shift in the GPC traces for the 50 kDa blend series with increased loading of the LMW component. The shift to a lower molecular weight, as well as a broadening of the PDI, is consistent with good incorporation of the LMW additive into the bulk material.

TABLE 3
Blend incorporation of 50 kDa LMW series

| Sample | Mₙ (×10³) | M_{w} (×10³) | PDI |
|---|---|---|---|
| 100% HMW | 109 | 220 | 2.0 |
| 3 mol % LMW | 87 | 213 | 2.4 |
| 10 mol % LMW | 83 | 206 | 2.5 |
| 15 mol % LMW | 71 | 194 | 2.8 |
| 100% LMW | 36 | 54 | 1.5 |

Mechanical testing of the tensile specimens provides a quantification of the improvement of interfacial adhesion with the addition of a LMW additive. See Table 4, below.

TABLE 4
Tensile Properties of Tensile Specimens.

| | | Max | | | |
|---|---|---|---|---|---|
| LMW | LMW PLA | Stress | Max Stress | Modulus | Modulus |
| additive | Blend % | Longitudinal | Transverse | Longitudinal | Transverse |
| (M_{w}) | (mol %) | (MPa) | (MPa) | (GPa) | (GPa) |
| 8.5k | 0 | 40.96 +/− 2.61 | 15.54 +/− 2.02 | 0.546 +/− 0.044 | 0.484 +/− 0.024 |
| | 3 | 28.68 +/− 1.97 | 15.09 +/− 0.59 | 0.490 +/− 0.040 | 0.510 +/− 0.020 |
| | 10 | 38.29 +/− 3.84 | 12.39 +/− 6.20 | 0.507 +/− 0.030 | 0.549 +/− 0.050 |
| | 15 | —* | —* | —* | —* |
| 50k | 0 | 40.96 +/− 2.61 | 15.54 +/− 2.02 | 0.546 +/− 0.044 | 0.484 +/− 0.024 |
| | 3 | 44.18 +/− 3.88 | —** | 0.600 +/− 0.200 | —** |
| | 10 | 45.44 +/− 2.5 | 26.6 +/− 1.56 | 0.610 +/− 0.090 | 0.630 +/− 0.120 |
| | 15 | 44.04 +/− 4.13 | 16.54 +/− 4.03 | 0.560 +/− 0.070 | 0.543 +/− 0.060 |
| 100k | 0 | 40.96 +/− 2.61 | 15.54 +/− 2.02 | 0.546 +/− 0.044 | 0.484 +/− 0.024 |
| | 3 | 45.70 +/− 1.33 | 7.16 +/− 0.60 | 0.570 +/− 0.080 | 0.639 +/− 0.095 |
| | 10 | 37.43 +/− 4.36 | 9.15 +/− 3.92 | 0.630 +/− 0.120 | 0.630 +/− 0.160 |
| | 15 | 38.32 +/− 6.81 | 9.47 +/− 3.52 | 0.543 +/− 0.060 | 0.579 +/− 0.140 |

*8.5k LMW PLA at 15 mol % loading could not be extruded into a useable filament;
**50k LMW PLA at 3 mol % loading transverse samples consistently broke in the grip and thus the data was excluded.

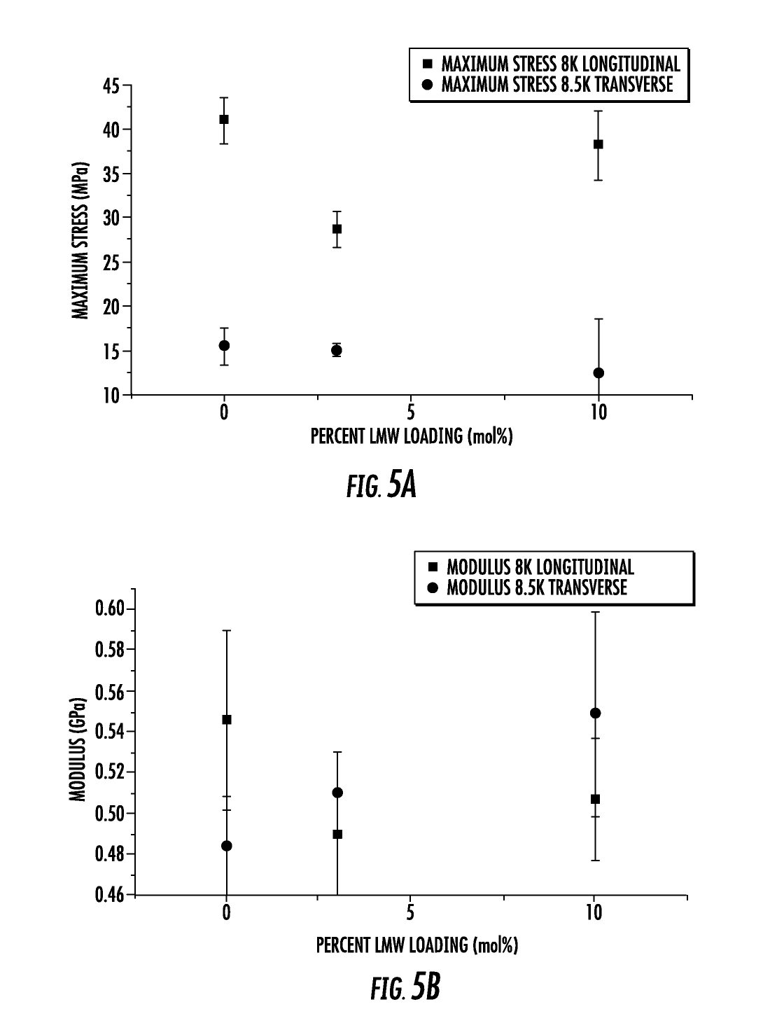

FIG. 5A plots the maximum stress as a function of the percent loading of the 8.5 kDa LMW component. At this molecular weight, regardless of loading and printing orientation, there is a decrease in the maximum stress relative to that of the neat samples. At this chain size, the LMW component appears to lack the ability to significantly entangle across the interlayer interface. Ultimately, this can hinder stress transfer, which benefits from the formation of a highly entangled network, and result in failure at low levels of stress. Moreover, FIG. 5B highlights that with the addition of the 8.5 kDa LMW additive, the moduli in the longitudinal and transverse print orientations become nearly equivalent, demonstrating that the printed parts are now more isotropic. This data is believed to indicate that the diffusion of the 8.5 kDa additive occurs readily during the printing process for all loadings. The 15 mol % 8.5 kDa sample could not be extruded into a useable filament, presumably because of the lower viscosity of this sample. In the longitudinal direction, a large drop in the maximum stress is reported with addition of the lower molecular weight polymer. This again is believed to be a consequence of the fact that the LMW chains are of insufficient length to readily entangle. Moreover, the presence of the smaller chains can inhibit the entanglement of the large chains throughout the filament.

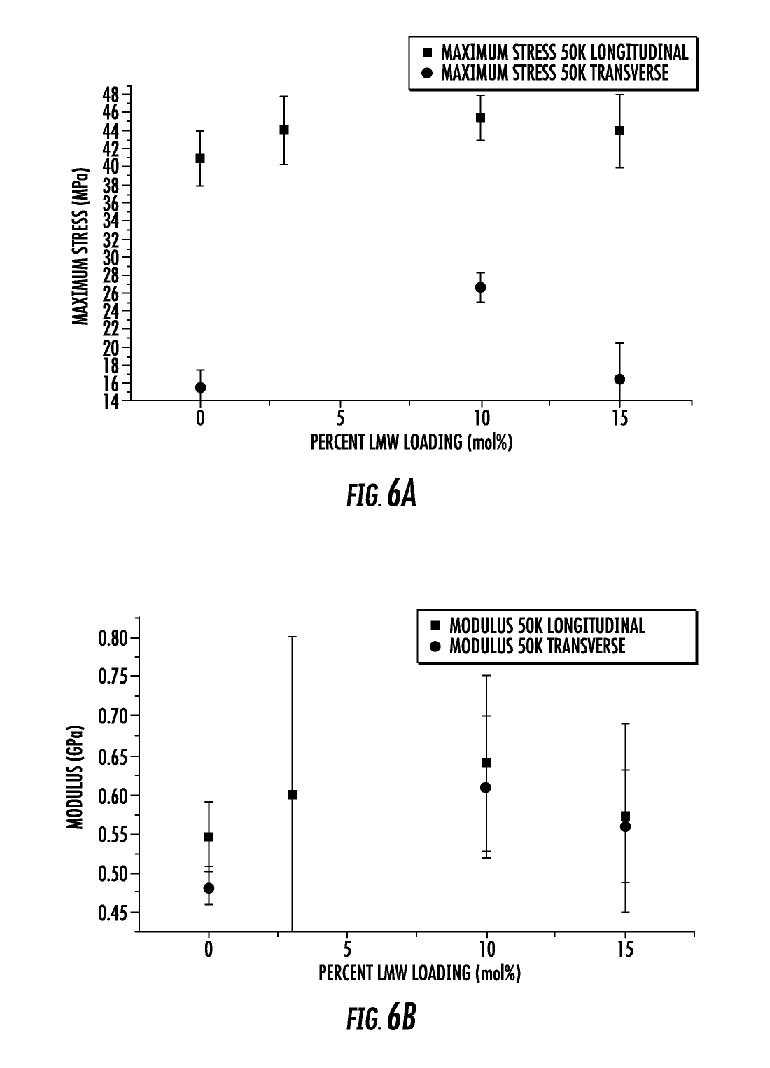

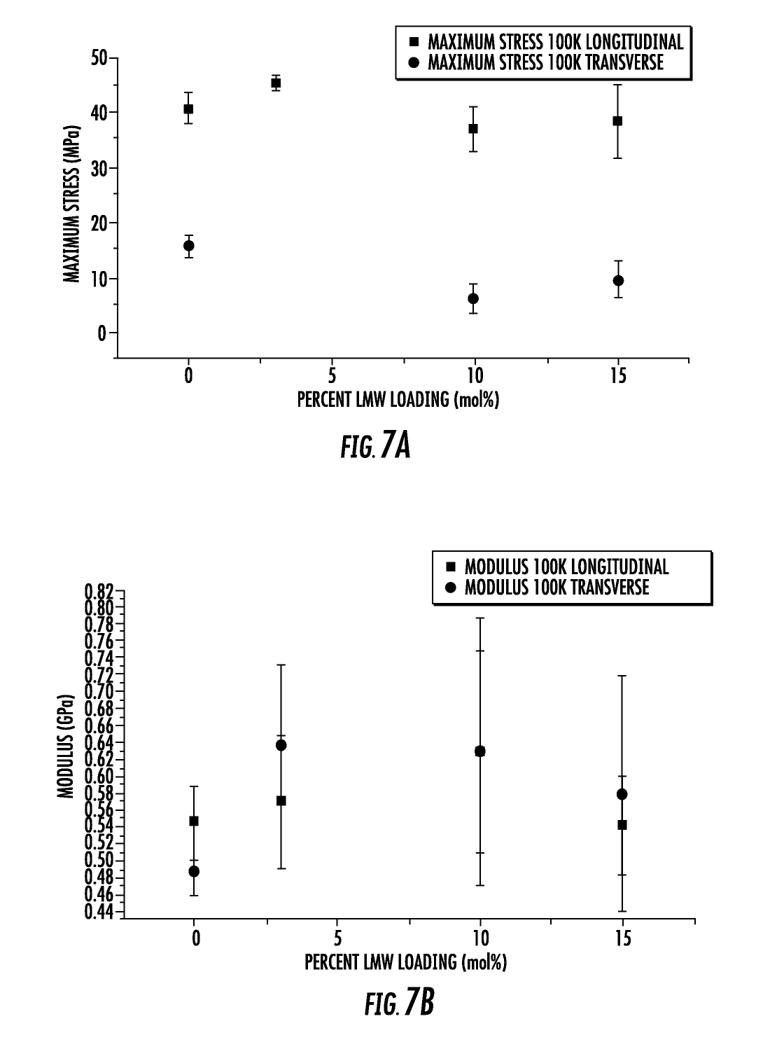

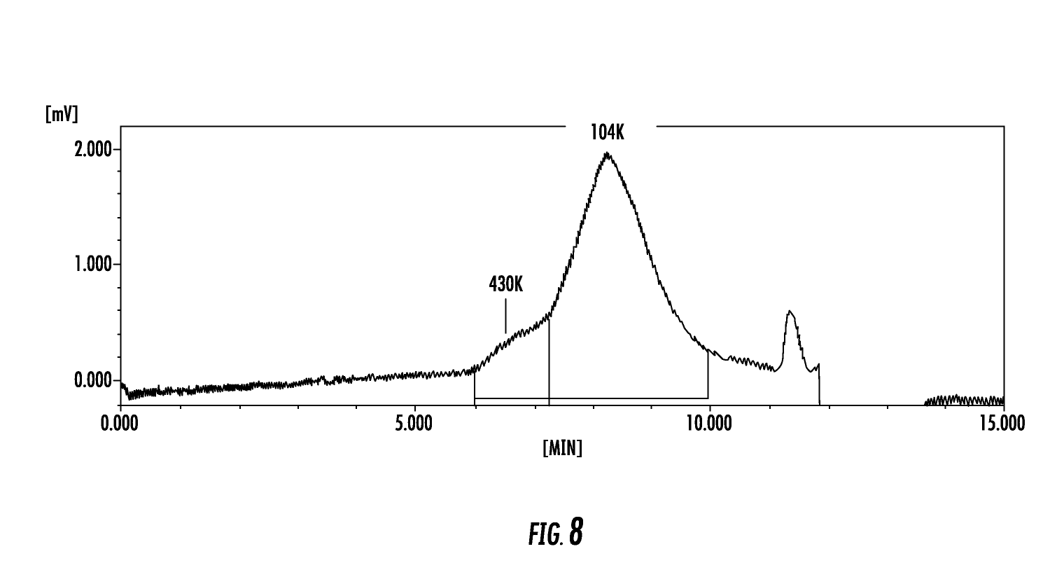

The stress-strain properties of the bimodal filament sample fabricated using the 50 kDa PLA are shown in FIGS. 6A and 6B. Failure occurred consistently within the grips of the testing machine for the 3 mol % samples and therefore those results are not reported. FIG. 6A shows that at 10 mol % loadings of the 50 kDa LMW component, the maximum stress in the transverse orientation increases by 66% over that of the neat sample. This indicates a substantial increase in inter-layer adhesion. Additionally, at 15 mol % an improvement of approximately 15% is observed. The improvement in the maximum stress is interpreted to indicate enhanced entanglement across layers due to the presence of the faster moving, lower molecular weight polymer. At 50 kDa, the LMW chains are sufficiently above the Mₑ such that they can readily entangle, but the MW is not so high as to hinder the diffusion of the LMW chains across the interface during the printing process. Inspection of the moduli of the samples with 50 kDa PLA in FIG. 6B, shows that these samples behave similar to the 8.5 kDa LMW samples, where the addition of the lower molecular weight chains produces a more isotropic sample. Additionally, an approximately 10% improvement in the modulus is observed for the 10 mol % 50 kDa sample and an approximately 1% improvement for the 15 mol % 50 kDa sample, further indicating an improvement in the interfacial adhesion. More significantly, the samples with 50 kDa additive dramatically improve the interdiffusion of the polymer chain across the layer, indicating a beneficial plasticizing effect, which can result in an improvement in the layer adhesion. It appears that it is beneficial that selection of molecular weight and loading balance the plasticizing effect afforded by lower molecular weight chains with the enhancement in layer adhesion afforded by interdiffusion and entanglement of higher molecular weight chains.

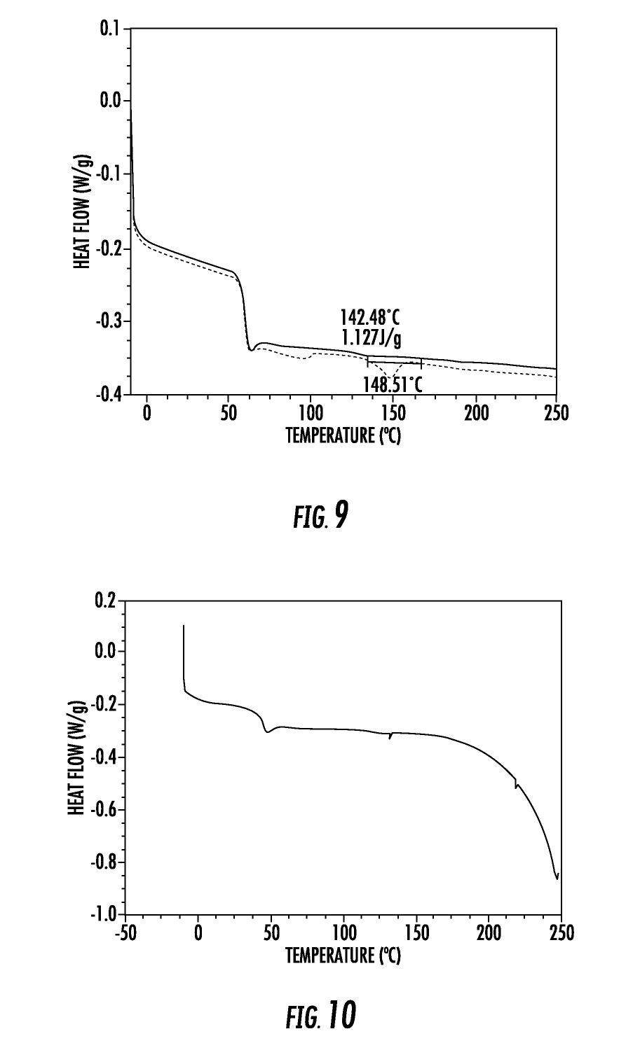

To further illustrate the benefits of this control, the tensile properties of the 100 kDa LMW series were studied and are plotted in FIGS. 7A and 7B. FIG. 7A shows that the maximum stress in the transverse orientation decreases with addition of the 100 kDa polymer, indicating that interfacial adhesion is actually hindered by its presence. Inspection of the GPC trace of the 100 kDa sample (see FIG. 8) indicates that a large portion of polymer chains are very long (>430 kDa, which is nearly double that of the neat material). The presence of these longer chains can limit the diffusion and entanglement of the polymers across the interlayer interface. Inspection of FIG. 7B shows the moduli of the sample in the transverse and longitudinal directions are more isotropic and higher than the neat sample. While this would seem to indicate an improvement in the material, this behavior appears to be dictated by the LMW components that are present in the sample. More specifically, it is believed that diffusion of the polymer across the interlayer interface still occurs via the LMW component, yielding a part that is more isotropic. However, the mechanical behavior is dominated by the high molecular weight fraction, resulting in poor interlayer adhesion. The data further indicates the benefits of balancing the plasticizing effect of the LMW chains with the enhancement in layer adhesion afforded by the diffusion and entanglement of the higher molecular weight chains.

The results obtained indicate that optimum conditions that augment both the maximum stress and the modulus are accessible simply by tuning the molecular weights and loadings of the LMW component. As discussed above, the 8.5 kDa series exhibits a decrease in the maximum stress in both print orientations due to the presence of the low molecular weight polymer, which translates to poor entanglement at the inter-filament interfaces. Additionally, the modulus decreases to 0.5 GPa, but becomes more isotropic. This behavior indicates that the 8.5 kDa LMW additive readily plasticizes the filament which translates to isotropic properties, but is not large enough to increase the entanglements at the inter-layer interface. On the other extreme, the addition of the 100 kDa LMW material to the filament results in less than optimal properties. The maximum stress in the transverse direction decreases with added 100 kDa PLA, due to the slow diffusion of the higher molecular weight chains in this broadly distributed sample, maintaining a weak interface. As with the samples with the 8.5 kDa additive, the samples with 100 kDa LMW chains have an isotropic modulus that fluctuates around 0.6 GPa. The ability of the lower molecular weight fraction of the 100 kDa additive to plasticize the sample is exacerbated by the presence of the HMW components in the blend, which hinder diffusion of chains that could potentially entangle across the interface. Lastly, the samples with the 50 kDa additive exhibit an increase in the maximum stress indicating a significant increase in the interfacial adhesion. Furthermore, a very isotropic modulus of approximately 0.6 GPa is observed at 10 mol % of the 50 kDa LMW polymer and above. Thus, it appears that the 50 kDa LMW additive is optimal for the exemplary blends studied, as it offers both an improvement in interfacial adhesion and an isotropic modulus. These results therefore suggest that the addition of a low molecular fraction to FDM filament materials can be a straightforward and cost effective method to improve inter-layer adhesion, and that the selection of a LMW additive that balances the plasticizing effect of the additive with the ability to entangle and improve the interfacial adhesion provides optimal improvement in tensile properties. For the limited molecular weights examined here, the 50 kDa LMW samples fit this criteria and offers the best opportunity to enhance the interlayer adhesion of an FDM printed part.

The finished print quality was also indicative of the ability of the low molecular weight additive to improve the mechanical isotropy of these 3D printed samples. In comparison to the neat sample, the sample comprising 8.5 kDa additive exhibited a heavily over extruded and rough appearance. This indicates that the 8.5 kDa component flows readily under the printing conditions and appears to be more isotropic, as distinction between layers is more difficult. However, the LMW chains cannot entangle and thus interlayer adhesion does not increase, as discussed above. Compared to the neat sample, the print quality and layer appearance of the sample containing 50 kDa additive was smoother and had less definition between layers. This is consistent with the enhancement of the layer adhesion in the 50 kDa LMW blended samples as shown by tensile testing. The 100 kDa additive-containing sample had well defined filament layers, a structure that can be expected with poor interlayer adhesion as observed in the tensile measurements. Thus, the macroscopic, finished part quality agrees with the mechanical testing experiments and indicates that, for the HMW polymer used in the exemplary blends, the 50 kDa 10 mol % sample provides the optimum printing conditions for samples with optimal mechanical and isotropic properties.

### Example 3

### Crystallization Studies

Samples were obtained before single screw extrusion, after single screw extrusion and after printing. Melt temperature (Tₘ) and crystallization temperature (T_{c}) were determined from the heat flow measured on a TA Instruments Q-2000 differential scanning calorimeter (TA Instruments, New Castle, Del., United States of America). Thermal control of the samples was implemented using a cyclic program in which the sample was heated from 10° C.−180° C. with a ramp rate of 10° C./min and then cooled at a rate of 20° C./min.

Discussion: PLA is a semi-crystalline polymer that under certain conditions can exhibit 40% crystallinity. See Tábi et al., eXPRESS Polym. Lett., 4, 659-668 (2010). The discussion above interprets the change in the mechanical properties, and its anisotropy, in terms of the inter-diffusion of the polymer chains across the inter-filament interface during the 3D printing process. However, it is also possible that the addition of the lower molecular weight materials can alter the crystallization processes that occur during the thermal treatment that is associated with the 3D printing process. Therefore, it the effects of the addition of the LMW material on the crystallization of PLA under the 3D printing conditions were also studied. The crystallinity of the PLA is monitored using differential scanning calorimetry (DSC) experiments. FIG. 9 shows the DSC curve of the as received, commercially available 220 kDa HMW PLA, while FIG. 10 shows the DSC curve of the LMW 50 kDa PLA sample. To monitor the impact of the addition of the LMW PLA to the crystallinity that exists in the final 3D printed structure, the percent crystallinity of the blends is determined in the bimodal filament after it exits the extruder, but before it is used in the 3D printing process and after it has been printed to account for shear induced crystallization. See Haas and Maxwell, Polym. Eng. Sci., 9, 225-241 (1969). In the experiments presented, the crystallinity of all samples is determined from the equation:

$$\% Crystallinity = \frac{Δ {H}_{m} - Δ {H}_{c}}{Δ {H}_{m}^{o}} * 100$$

where ΔHₘ and ΔH_{c} represent the enthalpy of melting and crystallization (J/g) respectively, and ΔHₘ^{o}, =75.57 J/g is the theoretical enthalpy of melting for a 100% crystalline PLA sample as determined by Tábi and co-workers. See Tábi et al., eXPRESS Polym. Lett., 4, 659-668 (2010). The thermal properties of the neat PLA samples used in this study are shown in Table 5, below.

TABLE 5
Thermal properties of 50 kDa LMW and commercial HMW PLA

| Sample | Tₘ (° C.) | T_{c} (° C.) | Enthalpy (J/g) | % Crystallinity |
|---|---|---|---|---|
| Blend with | N/A | N/A | N/A | 0 |
| LMW PLA | | | | |
| HMW PLA | 148.5 | 142.3 | 1.145 | 1.51 |

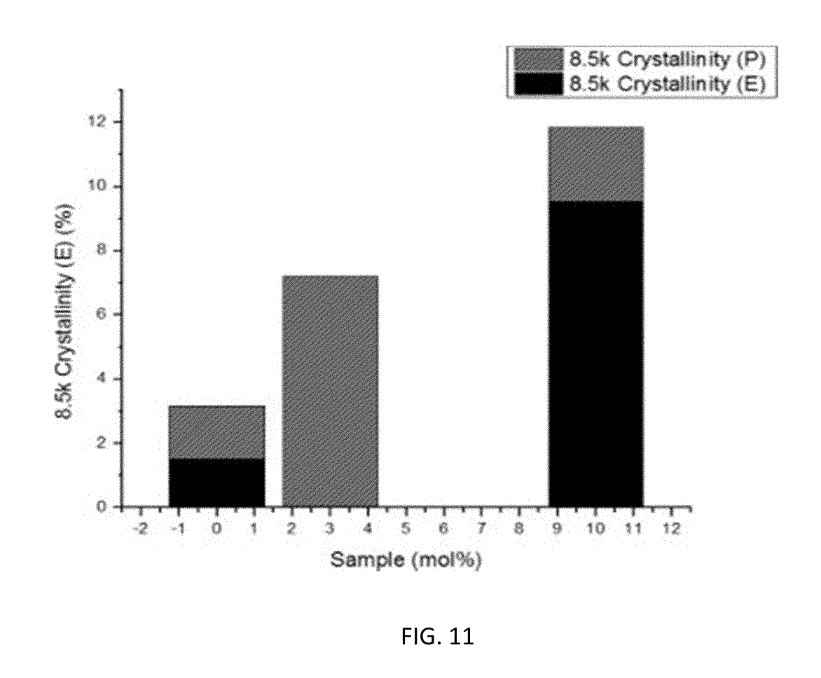

FIGS. 11-13 plot the percent crystallinity of each sample studied both after the filament is extruded from the single screw extruder and after the filament is used to 3D print the cubes from which the tensile dogbones were fabricated. The percent crystallinity in all the samples is small (<10%), and in particular, the amount of crystallinity in the extruded filament appears to be fairly random. Without being bound to any one theory, this is believed to be due to the relatively long cooling times required after extrusion from the die, where the exact cooling time is not well controlled. In many cases, this leads to a purely amorphous extrudate, as in the 50 kDa samples. However, in almost all instances an increase in crystallinity is observed after printing. This can be the result of shear induced crystallization arising from the high shear applied to the PLA chains as they are extruded through the small printer nozzle and the complex thermal history of the extrudate. See Talagani et al., SAMPE J., 51, 27-36 (2015).

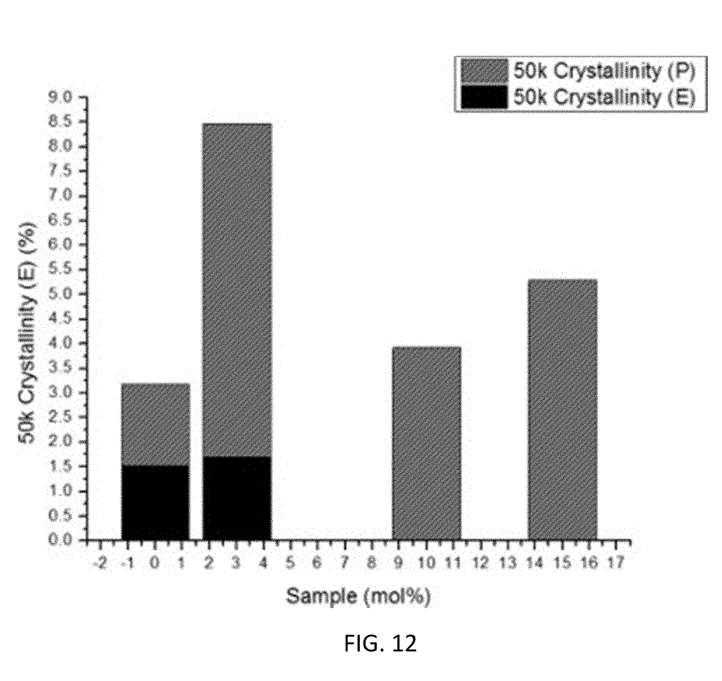

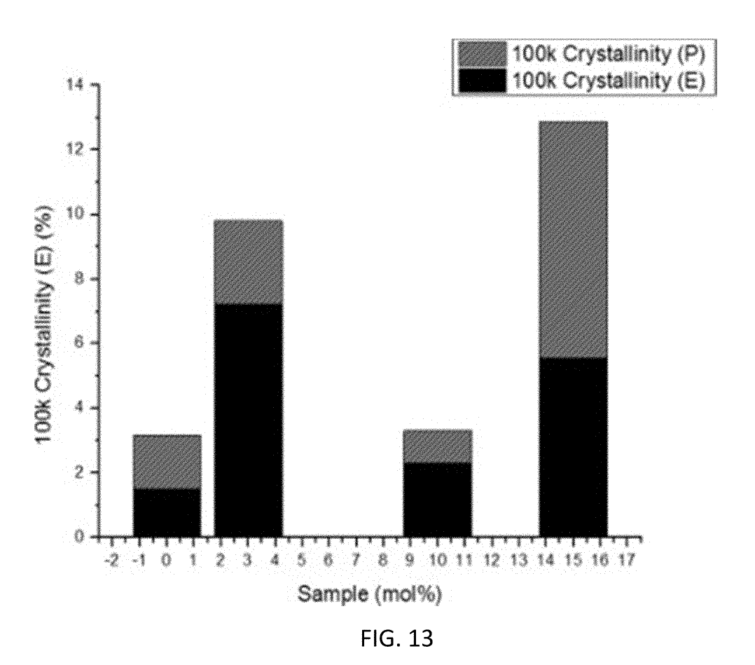

More precisely, FIG. 11 documents the crystallization behavior of the samples with 8.5 kDa LMW PLA. The data suggests that at low concentrations of LMW additive, the 8.5 kDa PLA acts as a plasticizing agent, providing the mobility needed to allow the longer polymer chains to orient into crystalline morphologies. However, at high loadings the LMW additive appears to act as a solvating agent which inhibits orientation of the large chains and prevents crystallization. This can further be observed in the 50 kDa series (see FIG. 12), where at low loadings an increase in crystallinity after printing is observed. In this case, though, it appears that the loading of the 50 kDa LMW PLA is not high enough to impede the crystallization of the PLA. Lastly, due to the large PDI of the 100 kDa PLA, the filaments containing the 100 kDa PLA show no discernable trend of the crystallinity of the extruded or printed samples. See FIG. 13.

Without being bound to any one theory, and taken as a whole, these studies indicate that crystallization under printing conditions does occur, though at relatively low (<10%) levels. Moreover, there is no recognizable correlation between the mechanical properties and the extent of crystallinity. Therefore, based on the present studies, it appears that the change in crystallinity of the PLA with addition of the LMW additive is not a major factor in influencing the formation and properties of the interlayer interface.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A polymer blend comprising:
(a) a high molecular weight (HMW) thermoplastic polymer, and
(b) a low molecular weight (LMW) thermoplastic polymer;
wherein the HMW thermoplastic polymer has a weight average molecular weight (M_{w}) that is at least two times greater than the M_{w} of the LMW thermoplastic polymer; wherein the blend comprises between 0.5 weight % and about 15 weight % of the LMW thermoplastic polymer; and wherein the HMW thermoplastic polymer and/or the LMW thermoplastic polymer are each independently selected from the group consisting of poly(lactic acid (PLA), acrylonitrile butadiene styrene terpolymer (ABS), a polyetherimide (PEI), polyethyl ether ketone (PEEK), a polyether ketone ketone (PEKK), a polystyrene (PS), polyphenylsulfone (PPSF), glycol-modified polyethylene terephthalate (PETG), a polyester, a polyamide (PA), and polycarbonate (PC).

2. The polymer blend of claim 1, wherein the M_{w} of the HMW thermoplastic polymer is four to eight times greater than the M_{w} of the LMW thermoplastic polymer.

3. The polymer blend of claim 1, wherein the HMW thermoplastic polymer and/or the LMW thermoplastic polymer are selected from the group consisting of PLA and ABS.

4. The polymer blend of claim 1, wherein the LMW thermoplastic polymer has a M_{w} that is greater than the entanglement molecular weight (Mₑ) of the thermoplastic polymer.

5. The polymer blend of claim 1, wherein the HMW thermoplastic polymer and the LMW thermoplastic polymer are polymers derived from the polymerization of the same monomer or monomers.

6. The polymer blend of claim 5, wherein the HMW thermoplastic polymer and the LMW thermoplastic polymer are both PLA.

7. The polymer blend of claim 6, wherein the LMW thermoplastic polymer has a M_{w} of between about 25,000 g/mol and about 100,000 g/mol.

8. The polymer blend of claim 7, wherein the LMW thermoplastic polymer has a M_{w} of about 50,000 g/mol.

9. The polymer blend of claim 7, wherein the LMW thermoplastic polymer comprises between about 3 mole percentage (mol %) and about 15 mol % of the blend.

10. The polymer blend of claim 7, wherein the LMW thermoplastic polymer has a M_{w} of about 50,000 g/mol and comprises about 10 mol % of the blend.

11. The polymer blend of claim 7, wherein the blend has a polydispersity index (PDI) of between about 2.1 and about 3.0.

12. A filament comprising a polymer blend, wherein the polymer blend comprises: (a) a high molecular weight (HMW) thermoplastic polymer, and (b) a low molecular weight (LMW) thermoplastic polymer; wherein the HMW thermoplastic polymer has a weight average molecular weight (M_{w}) that is at least two times greater than the M_{w} of the LMW thermoplastic polymer; and wherein the blend comprises between 0.5 weight % and about 5 weight % of the LMW thermoplastic polymer.

13. The filament of claim 12, wherein the HMW thermoplastic polymer and/or the LMW thermoplastic polymer are each independently selected from the group consisting of poly(lactic acid) (PLA), acrylonitrile butadiene styrene terpolymer (ABS), a polyetherimide (PEI), polyethyl ether ketone (PEEK), a polyether ketone ketone (PEKK), a polystyrene (PS), polyphenylsulfone (PPSF), glycol-modified polyethylene terephthalate (PETG), a polyester, a polyamide (PA), and polycarbonate (PC).

14. The filament of claim 12, wherein the M_{w} of the HMW thermoplastic polymer is about four to eight times greater than the M_{w} of the LMW thermoplastic polymer.

15. The filament of claim 12, wherein the LMW thermoplastic polymer has a M_{w} that is greater than the entanglement molecular weight (Mₑ) of the thermoplastic polymer.

16. The filament of claim 12, wherein the HMW thermoplastic polymer and the LMW thermoplastic polymer are polymers derived from the polymerization of the same monomer or monomers.

17. The filament of claim 16, wherein the HMW thermoplastic polymer and the LMW thermoplastic polymer are both PLA.

18. The filament of claim 17, wherein the LMW thermoplastic polymer has a M_{w} of between about 25,000 g/mol and about 100,000 g/mol.

19. The filament of claim 18, wherein the LMW thermoplastic polymer has a M_{w} of about 50,000 g/mol.

20. The filament of claim 18, wherein the LMW thermoplastic polymer comprises between about 3 mole percentage (mol %) and about 15 mol % of the blend.

21. The filament of claim 18, wherein the LMW thermoplastic polymer has a M_{w} of about 50,000 g/mol and comprises about 10 mol % of the blend.

22. The filament of claim 12, wherein the filament has a diameter of between about 4 mm and about 0.5 mm.

23. The filament of claim 12, further comprising one or more additives selected from the group consisting of pigments, UV stabilizers, UV absorbers, antioxidants, lubricity agents, heat stabilizers, hydrolysis stabilizers, cross-linking activators, flame retardants, layered silicates, an organic or inorganic filler, a colorant, an adhesion mediator, an impact strength modifier, an antimicrobial, and combinations thereof.

24. A three-dimensional object comprising a plurality of adjacent layers of the filament of claim 12.

25. The three-dimensional object of claim 24, wherein the object has improved isotropic properties compared to an object of the same design prepared from a filament comprising no LMW thermoplastic polymer.

26. The three-dimensional object of claim 25, wherein the difference between the modulus measured in the transverse direction and the modulus measured in the longitudinal direction is 0.02 gigapascals (GPa) or less.

27. The three-dimensional object of claim 25, wherein the difference between the stress at yield measured in the transverse direction and the stress at yield measured in the longitudinal direction is 15 megapascals (MPa) or less.

28. The three-dimensional object of claim 25, wherein one or more of the maximum stress in the longitudinal direction, the maximum stress in the transverse direction, the modulus in the longitudinal direction, the modulus in the transverse direction, and the toughness is higher than that of an object of the same design prepared from a filament comprising no LMW thermoplastic polymer.

29. The three-dimensional object of claim 25, wherein the maximum stress in the transverse direction is at least 40% greater than in an object of the same design prepared from a filament comprising no LMW thermoplastic polymer.

30. The three-dimensional object of claim 25, wherein the modulus in the transverse direction is at least 25% greater than in an object of the same design prepared from a filament comprising no LMW thermoplastic polymer.

31. A method of preparing a three-dimensional object, wherein the method comprises:
(i) providing a filament of claim 12;
(ii) heating the filament; and
(iii) dispensing heated filament to form a plurality of adjacent layers of dispensed filament, thereby preparing the three-dimensional object.

32. The method of claim 31, wherein step (iii) comprises:
(1) dispensing heated filament from a print head while moving the print head in a first two dimensional plane to form a first layer of dispensed filament on a support surface;
(2) moving the print head or support surface in a direction perpendicular to the first two dimensional plane;
(3) dispensing heated filament from the print head while moving the print head in a second two dimensional plane, wherein the second two dimensional plane is parallel to the two dimensional plane of step (1) to form a second layer of dispensed filament, wherein a least a portion of the second layer is in contact with the first layer; and
(4) repeating the moving of the print head or support surface and the dispensing of heated filament to form one or more additional layers layer-by-layer, wherein each of the additional layers is in contact with at least a portion of the adjacent layer or layers.

33. The method of claim 32, wherein the movement of the print head and/or the support surface is controlled by a motor and/or computer.

34. A method of improving the isotropy of an object prepared via a fused deposition modeling three-dimensional printing process, wherein the method comprises adding a low molecular weight polymer to a high molecular weight polymer to provide a bimodal polymer blend for use in preparing a building material for the object, wherein the addition of the low molecular weight polymer improves interfacial adhesion between layers of building material within the object.
